(19) United States
(12) Patent Application Publication
(10) Pub. No.: US 2016/0275518 A1
(43) Pub. Date: Sep. 22, 2016

(54) DEVICE RECYCLING SYSTEMS WITH FACIAL RECOGNITION

(71) Applicant: ecoATM, Inc., San Diego, CA (US)

(72) Inventors: Mark Vincent Bowles, San Diego, CA (US); Jeffrey Ploetner, San Diego, CA (US); John Andrew Beane, San Diego, CA (US); Andrew Spaventa, San Diego, CA (US)

(21) Appl. No.: 14/663,331

(22) Filed: Mar. 19, 2015

(51) Int. Cl. G06Q 20/40; G06K 9/52; G06K 9/00; G06K 9/62; G06Q 10/00; G06Q 20/18

(52) U.S. Cl. CPC G06Q 20/40145; G06Q 10/30; G06Q 20/18; G06K 9/00255; G06K 9/6215; G06K 9/00288; G06K 9/52; G06K 9/00268; G06K 9/00087; G06K 9/00302

(57) ABSTRACT

Hardware and/or software systems and associated methods for user verification at a kiosk are described herein. In various embodiments, the present technology includes systems and methods associated with verifying that a user matches an identification photo, comparing a user at a kiosk to a known image of the user, comparing a user's image to images of persons who are blocked from kiosk use, recognizing the presence of potential hawkers, etc. Various other aspects of the present technology are described herein.

### TECHNICAL FIELD

The present disclosure is generally directed to methods and systems for evaluating and recycling mobile phones and other consumer electronic devices and, more particularly, to hardware and/or software systems and associated methods for facial recognition, user verification, and/or other identification processes associated with electronic device recycling.

### BACKGROUND

Consumer electronic devices, such as mobile phones, laptop computers, notebooks, tablets, MP3 players, etc., are ubiquitous. Currently there are over 6 billion mobile devices in use in the world; and the number of these devices is growing rapidly with more than 1.8 billion mobile phones being sold in 2013 alone. By 2017 it is expected that there will be more mobile devices in use than there are people on the planet. In addition to mobile phones, over 300 million desk-based and notebook computers shipped in 2013, and for the first time the number of tablet computers shipped exceeded the number of laptops shipped. Part of the reason for the rapid growth in the number of mobile phones and other electronic devices is the rapid pace at which these devices evolve, and the increased usage of such devices in third world countries.

As a result of the rapid pace of development, a relatively high percentage of electronic devices are replaced every year as consumers continually upgrade their mobile phones and other electronic devices to obtain the latest features or a better service plan. According to the U.S. Environmental Protection Agency, the U.S. alone disposes of over 370 million mobile phones, PDAs, tablets, and other electronic devices every year. Millions of other outdated or broken mobile phones and other electronic devices are simply tossed into junk drawers or otherwise kept until a suitable disposal solution arises.

Although many electronic device retailers and cell carrier stores now offer mobile phone trade-in or buyback programs, many old mobile phones still end up in landfills or are improperly disassembled and disposed of in developing countries. Unfortunately, however, mobile phones and similar devices typically contain substances that can be harmful to the environment, such as arsenic, lithium, cadmium, copper, lead, mercury, and zinc. If not properly disposed of, these toxic substances can seep into groundwater from decomposing landfills and contaminate the soil with potentiality harmful consequences for humans and the environment.

As an alternative to retailer trade-in or buyback programs, consumers can now recycle and/or sell their used mobile phones using self-service kiosks located in malls, retail stores, or other publically accessible areas. Such kiosks are operated by ecoA™, Inc., the assignee of the present application, and are disclosed in, for example, U.S. Pat. Nos. 8,463,646, 8,423,404, 8,239,262, 8,200,533, 8,195,511, and 7,881,965, which are commonly owned by ecoA™, Inc. and are incorporated herein by reference in their entireties.

In some jurisdictions, electronic device recycling kiosks must comply with second-hand dealer regulations by confirming the identity of each user before accepting an electronic device for recycling. To comply with these regulations, such kiosks can photograph the user and scan the user's driver's license, and then transmit the images to a remote screen where a human operator can compare the image of the user to the driver's license to verify the user's identity. The operator can prevent the user from proceeding with the recycling transaction if the operator cannot verify the user's identity or if the user is underage. Such identity verification can ensure that users are legally able to conduct transactions and can discourage users from selling electronic devices that they do not own.

### BRIEF DESCRIPTION OF THE DRAWINGS

FIG. 1 is an isometric view of a machine configured in accordance with an embodiment of the present technology for recycling electronic devices.

FIGS. 2A-2D are a series of isometric views of the machine of FIG. 1 with a number of exterior panels removed to illustrate operation of the machine in accordance with an embodiment of the present technology.

FIGS. 3A-3C are schematic diagrams illustrating components and data flows in user verification systems configured in accordance with embodiments of the present technology.

FIG. 4 is a flow diagram of a routine for comparing a photograph of a user's face to a picture from an identification card in accordance with an embodiment of the present technology.

FIG. 5 illustrates a display page for facilitating remote ID verification in accordance with an embodiment of the present technology.

FIG. 6 is a flow diagram of a routine for verifying a user's identity in accordance with an embodiment of the present technology.

FIG. 7 is a table of known users configured in accordance with an embodiment of the present technology.

FIG. 8 is a flow diagram of a routine for identifying a blocked user in accordance with an embodiment of the present technology.

FIG. 9 is a flow diagram of a routine for recognizing headwear or eyewear in accordance with an embodiment of the present technology.

FIGS. 10A and 10B are display pages illustrating screen displays associated with prompting a user to remove headwear and/or eyewear in accordance with embodiments of the present technology.

FIG. 11 is a flow diagram of a routine for comparing a photograph of a user to identification information in accordance with an embodiment of the present technology.

FIG. 12 is a flow diagram of a routine for gauging emotional reactions of a kiosk user in accordance with an embodiment of the present technology.

FIG. 13 is a flow diagram of a routine to identify potential hawkers in accordance with an embodiment of the present technology.

FIG. 14 is a flow diagram of a routine for assessing kiosk traffic in accordance with an embodiment of the present technology.

FIG. 15 is a schematic diagram illustrating various components associated with the machine of FIG. 1 configured in accordance with an embodiment of the present technology.

FIG. 16 is a schematic diagram of a suitable distributed computing environment for implementing various aspects of the present technology in accordance with an embodiment of the present technology.

FIG. 17 is a flow diagram of a routine for verifying the identity of a mobile device user in accordance with an embodiment of the present technology.

### DETAILED DESCRIPTION

The following disclosure describes various embodiments of hardware and software systems and methods to facilitate user recognition, ID verification, and/or other individual identification processes associated with recycling electronic devices. In some embodiments, for example, the systems and methods described in detail herein employ automated facial recognition technology to verify the identity of a customer who wishes to use an automated electronic device recycling kiosk. Such systems and methods can facilitate a comparison of an image of the user (e.g., the user's face) to a driver's license photo and/or other photographic records to verify the identity of the user. In various embodiments, the present technology includes systems and methods associated with verifying that a photograph of the user at the kiosk matches an ID card photo to augment human authentication, comparing the photograph of the user to a known image of the user to confirm the user's identity, and/or comparing a user's image to images of individuals who have attempted fraudulent transactions at the kiosk to prevent blocked individuals from using the kiosk.

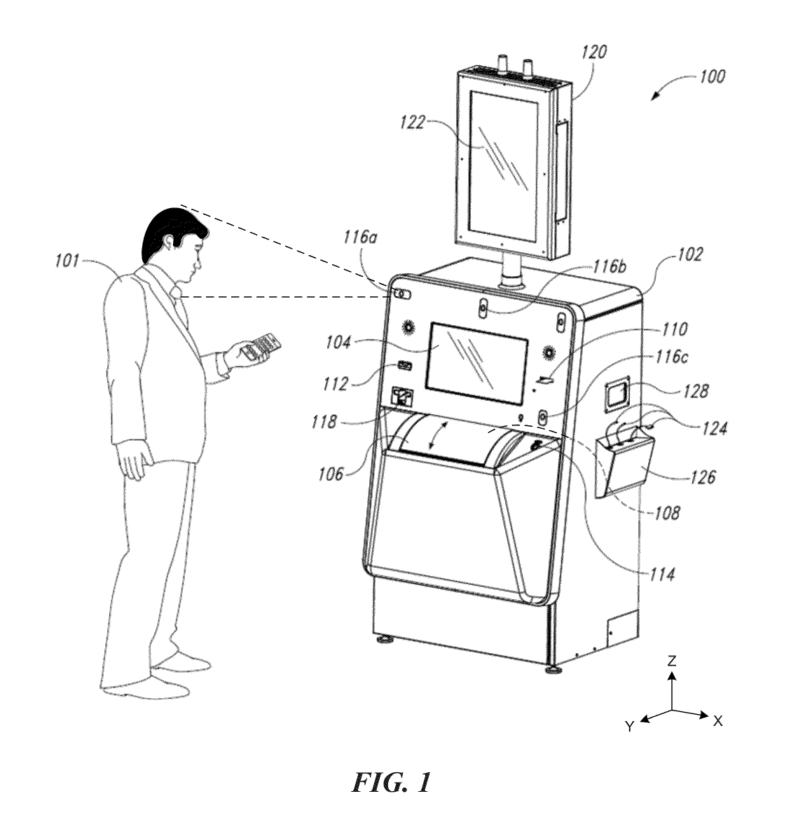

Certain details are set forth in the following description and in FIGS. 1-17 to provide a thorough understanding of various embodiments of the present technology. In other instances, well-known structures, materials, operations and/or systems often associated with consumer operated kiosks, smartphones and other handheld devices, consumer electronic devices, computer hardware, software, and network systems, etc. are not shown or described in detail in the following disclosure to avoid unnecessarily obscuring the description of the various embodiments of the present technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the present technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a kiosk 100 for recycling and/or other processing of mobile phones and other consumer electronic devices in accordance with an embodiment of the present technology. The term “processing” is used herein for ease of reference to generally refer to all manner of services and operations that may be performed or facilitated by the kiosk 100 on, with, or otherwise in relation to an electronic device. Such services and operations can include, for example, selling, reselling, recycling, donating, exchanging, identifying, evaluating, pricing, auctioning, decommissioning, transferring data from or to, reconfiguring, refurbishing, etc. mobile phones and other electronic devices. The term “recycling” is used herein for ease of reference to generally refer to selling and/or purchasing, reselling, exchanging, donating and/or receiving, etc. electronic devices. For example, owners may elect to sell, donate, or otherwise deposit their used electronic devices (e.g., used mobile phones) at the kiosk 100, and the electronic devices can be recycled for reconditioning, repair, and/or resale; recovery of salvageable components; environmentally conscious disposal; etc.

Although many aspects of the kiosk 100 are described herein in the context of mobile phones, those of ordinary skill in the art will appreciate that the kiosk 100 is not limited to mobile phones and that various embodiments of the kiosk 100 can be used for recycling virtually any type of consumer electronic device. Such devices include, as non-limiting examples, all manner of mobile phones; smartphones; handheld devices; personal digital assistants (PDAs); MP3 or other digital music players; tablet, notebook, ultrabook, and laptop computers; e-readers; all types of cameras; GPS devices; set-top boxes and other media players; VoIP phones; universal remote controls; speakers; headphones; wearable computers; etc. In some embodiments, it is contemplated that the kiosk 100 can facilitate selling and/or otherwise processing larger consumer electronic devices, such as desktop computers, TVs, projectors, DVRs, game consoles, Blu-Ray Disc™ players, printers, network attached storage devices, etc.; as well smaller electronic devices such as Google® Glass™, smartwatches (e.g., the Apple Watch™, Android Wear™ devices such as the Moto 360®, or the Pebble Steel™ watch), fitness bands, thumb drives, wireless hands-free devices; unmanned aerial vehicles; etc.

The kiosk 100 and/or various features thereof can be at least generally similar in structure and function to the kiosks and corresponding features described in U.S. Pat. No. 8,195,511, filed on Oct. 2, 2009, and titled “SECONDARY MARKET AND VENDING SYSTEM FOR DEVICES”; U.S. Pat. No. 7,881,965, filed on Mar. 19, 2010, and titled “SECONDARY MARKET AND VENDING SYSTEM FOR DEVICES”; U.S. Pat. No. 8,200,533, filed on May 23, 2010, and titled “APPARATUS AND METHOD FOR RECYCLING MOBILE PHONES”; U.S. Pat. No. 8,239,262, filed on Jan. 31, 2011, and titled “SECONDARY MARKET AND VENDING SYSTEM FOR DEVICES”; U.S. Pat. No. 8,463,646, filed on Jun. 4, 2012, and titled “SECONDARY MARKET AND VENDING SYSTEM FOR DEVICES”; and U.S. Pat. No. 8,423,404, filed on Jun. 30, 2012, and titled “SECONDARY MARKET AND VENDING SYSTEM FOR DEVICES”; and in U.S. patent application Ser. No. 13/113,497, filed on May 23, 2011, and titled “SECONDARY MARKET AND VENDING SYSTEM FOR PRINTER CARTRIDGES”; Ser. No. 13/438,924, filed on Apr. 4, 2012, and titled “KIOSK FOR RECYCLING ELECTRONIC DEVICES”; Ser. No. 13/492,835, filed on Jun. 9, 2012, and titled “APPARATUS AND METHOD FOR RECYCLING MOBILE PHONES”; Ser. No. 13/658,825, filed on Oct. 24, 2012, and titled “METHOD AND APPARATUS FOR RECYCLING ELECTRONIC DEVICES”; Ser. No. 13/658,828, filed on Oct. 24, 2012, and titled “METHOD AND APPARATUS FOR RECYCLING ELECTRONIC DEVICES”; Ser. No. 13/693,032, filed on Dec. 3, 2012, and titled “METHOD AND APPARATUS FOR REMOVING DATA FROM A RECYCLED ELECTRONIC DEVICE”; Ser. No. 13/705,252, filed on Dec. 5, 2012, and titled “PRE-ACQUISITION AUCTION FOR RECYCLED ELECTRONIC DEVICES”; Ser. No. 13/733,984, filed on Jan. 4, 2013, and titled “METHOD AND APPARATUS FOR RECYCLING ELECTRONIC DEVICES”; Ser. No. 13/753,539, filed on Jan. 30, 2013, and titled “METHOD AND APPARATUS FOR RECYCLING ELECTRONIC DEVICES”; Ser. No. 13/792,030, filed on Mar. 9, 2013, and titled “MINI-KIOSK FOR RECYCLING ELECTRONIC DEVICES”; Ser. No. 13/794,814, filed on Mar. 12, 2013, and titled “METHOD AND SYSTEM FOR REMOVING AND TRANSFERRING DATA FROM A RECYCLED ELECTRONIC DEVICE”; Ser. No. 13/794,816, filed on Mar. 12, 2013, and titled “METHOD AND SYSTEM FOR RECYCLING ELECTRONIC DEVICES IN COMPLIANCE WITH SECOND HAND DEALER LAWS”; Ser. No. 13/862,395, filed on Apr. 13, 2013, and titled “SECONDARY MARKET AND VENDING SYSTEM FOR DEVICES”; Ser. No. 13/913,408, filed on Jun. 8, 2013, and titled “SECONDARY MARKET AND VENDING SYSTEM FOR DEVICES”; Ser. No. 14/498,763, filed on Sep. 26, 2014, and titled “METHODS AND SYSTEMS FOR PRICING AND PERFORMING OTHER PROCESSES ASSOCIATED WITH RECYCLING MOBILE PHONES AND OTHER ELECTRONIC DEVICES”; U.S. patent application Ser. No. 14/500,739, filed on Sep. 29, 2014, and titled “MAINTAINING SETS OF CABLE COMPONENTS USED FOR WIRED ANALYSIS, CHARGING, OR OTHER INTERACTION WITH PORTABLE ELECTRONIC DEVICES”; U.S. provisional application No. 62/059,129, filed on Oct. 2, 2014, and titled “WIRELESS-ENABLED KIOSK FOR RECYCLING CONSUMER DEVICES”; U.S. provisional application No. 62/059,132, filed on Oct. 2, 2014, and titled “APPLICATION FOR DEVICE EVALUATION AND OTHER PROCESSES ASSOCIATED WITH DEVICE RECYCLING”; U.S. patent application Ser. No. 14/506,449, filed on Oct. 3, 2014, and titled “SYSTEM FOR ELECTRICALLY TESTING MOBILE DEVICES AT A CONSUMER-OPERATED KIOSK, AND ASSOCIATED DEVICES AND METHODS”; U.S. provisional application No. 62/073,840, filed on Oct. 31, 2014, and titled “SYSTEMS AND METHODS FOR RECYCLING CONSUMER ELECTRONIC DEVICES”; U.S. provisional application No. 62/073,847, filed on Oct. 31, 2014, and titled “METHODS AND SYSTEMS FOR FACILITATING PROCESSES ASSOCIATED WITH INSURANCE SERVICES AND/OR OTHER SERVICES FOR ELECTRONIC DEVICES”; U.S. provisional application No. 62/076,437, filed on Nov. 6, 2014, and titled “METHODS AND SYSTEMS FOR EVALUATING AND RECYCLING ELECTRONIC DEVICES”; U.S. patent application Ser. No. 14/568,051, filed on Dec. 11, 2014, and titled “METHODS AND SYSTEMS FOR IDENTIFYING MOBILE PHONES AND OTHER ELECTRONIC DEVICES”; and U.S. provisional application No. 62/090,855, filed on Dec. 11, 2014, and titled “METHODS AND SYSTEMS FOR PROVIDING INFORMATION REGARDING COUPONS/PROMOTIONS AT KIOSKS FOR RECYCLING MOBILE PHONES AND OTHER ELECTRONIC DEVICES”; and each of the patents and patent applications listed above, along with any other patents or patent applications identified herein, are incorporated herein by reference in their entireties.

In the illustrated embodiment, the kiosk 100 is a floor-standing self-service kiosk configured for use by a user 101 (e.g., a consumer, customer, etc.) to recycle, sell, and/or perform other operations with a mobile phone or other consumer electronic device. In other embodiments, the kiosk 100 can be configured for use on a countertop or a similar raised surface. Although the kiosk 100 is configured for use by consumers, in various embodiments the kiosk 100 and/or various portions thereof can also be used by other operators, such as a retail clerk or kiosk assistant to facilitate the selling or other processing of mobile phones and other electronic devices.

In the illustrated embodiment, the kiosk 100 includes a housing 102 that is approximately the size of a conventional vending machine. The housing 102 can be of conventional manufacture from, for example, sheet metal, plastic panels, etc. A plurality of user interface devices are provided on a front portion of the housing 102 for providing instructions and other information to users, and/or for receiving user inputs and other information from users. For example, the kiosk 100 can include a display screen 104 (e.g., a liquid crystal display (LCD) or light emitting diode (LED) display screen, a projected display (such as a heads-up display or a head-mounted device), and so on) for providing information, prompts, etc. to users. The display screen 104 can include a touch screen for receiving user input and responses to displayed prompts. In addition or alternatively, the kiosk 100 can include a separate keyboard or keypad for this purpose. The kiosk 100 can also include an ID reader or scanner 112 (e.g., a driver's license scanner), a biometric reader 114 (e.g., a fingerprint reader or an iris scanner), and one or more imaging devices or cameras 116 (e.g., digital still and/or video cameras, identified individually as cameras 116a-c). The ID scanner 112 can include an imaging device for obtaining an image of an ID card, a magnetic reader for obtaining data encoded on a magnetic stripe, a radio frequency identification (RFID) reader for reading information from an RFID chip, etc. The kiosk 100 can additionally include output devices such as a label printer having an outlet 110, and a cash dispenser having an outlet 118. Although not identified in FIG. 1, the kiosk 100 can further include a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), a receipt or voucher printer and dispenser, as well as other user input and output devices. The input devices may include a touchpad, a pointing device such as a mouse, a joystick, pen, game pad, motion sensor, scanner, eye direction monitoring system, etc. Additionally the kiosk 100 can also include a bar code reader, QR code reader, bag/package dispenser, a digital signature pad, etc. In the illustrated embodiment, the kiosk 100 additionally includes a header 120 having a display screen 122 for displaying marketing advertisements and/or other video or graphical information to attract users to the kiosk 100. In addition to the user interface devices described above, the front portion of the housing 102 also includes an access panel or door 106 located directly beneath the display screen 104. As described in greater detail below, the access door 106 is configured to automatically retract so that the user 101 can place an electronic device (e.g., a mobile phone) in an inspection area 108 for automatic inspection by the kiosk 100.

A sidewall portion of the housing 102 can include a number of conveniences to help users recycle or otherwise process their mobile phones. For example, in the illustrated embodiment the kiosk 100 includes an accessory bin 128 that is configured to receive mobile device accessories that the user wishes to recycle or otherwise dispose of. Additionally, the kiosk 100 can provide a free charging station 126 with a plurality of electrical connectors 124 for charging a wide variety of mobile phones and other consumer electronic devices.

Embodiments of the present technology are described herein in the context of the mobile phone recycling kiosk 100. In various other embodiments, however, the present technology can be utilized in other environments and with other machines, such as coin counting kiosks, gift card exchange kiosks, and DVD and/or Blu-Ray Disc™ rental kiosks. In addition, the present technology can be used with various other types of electronic device recycling machines. For example, embodiments of the present technology include countertop recycling stations and/or retail store-based point-of-sale recycling stations operated by or with the assistance of a retail employee. As another example, embodiments of the present technology include recycling machines configured to accept other kinds of electronic devices, including larger items (e.g., desktop and laptop computers, televisions, gaming consoles, DVRs, etc.). In addition, the present technology can be utilized with mobile electronic devices, such as a mobile device configured for evaluating other electronic devices. For example, embodiments of the present technology include a software application (“app”) running on a mobile device having a camera.

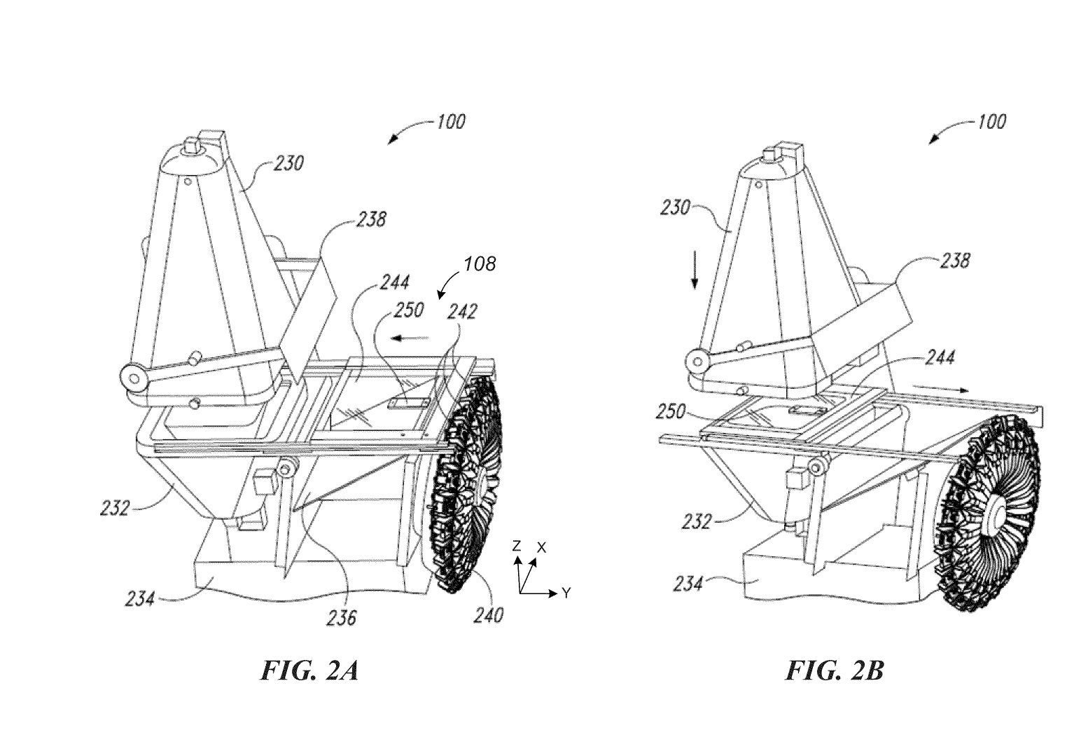

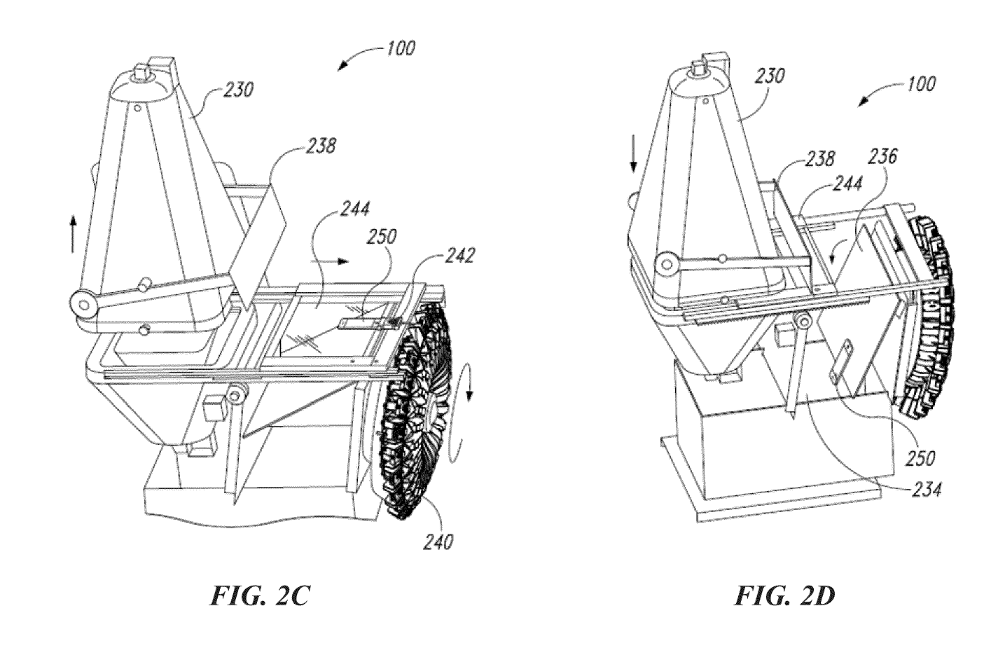

FIGS. 2A-2D are a series of isometric views of the kiosk 100 with the housing 102 removed to illustrate selected internal components configured in accordance with an embodiment of the present technology. Referring first to FIG. 2A, in the illustrated embodiment the kiosk 100 includes an inspection plate 244 operably disposed behind the access door 106 of FIG. 1 within the inspection area 108. A connector carrier 240 is disposed proximate to the inspection plate 244. In the illustrated embodiment, the connector carrier 240 is a rotatable carrousel that is configured to rotate about a generally horizontal axis and carries a plurality of electrical connectors 242 (e.g., approximately 25 connectors) distributed around an outer periphery thereof. In other embodiments, other types of connector carrying devices (including both fixed and movable arrangements) can be used. In some embodiments, the connectors 242 can include a plurality of interchangeable universal serial bus (USB) connectors configured to provide power and/or exchange data with a variety of different mobile phones and/or other electronic devices. In operation, the carrousel 240 is configured to automatically rotate about its axis to position an appropriate one of the connectors 242 adjacent to an electronic device, such as a mobile phone 250, that has been placed on the inspection plate 244 for recycling. The connector 242 can then be manually and/or automatically withdrawn from the carrousel 240 and connected to a port on the mobile phone 250 for electrical analysis. Such analysis can include, e.g., an evaluation of make, model, configuration, condition, etc. using one or more of the methods and/or systems described in detail in the commonly owned patents and patent applications identified herein and incorporated by reference in their entireties.

In the illustrated embodiment, the inspection plate 244 is configured to translate back and forth (on, e.g., parallel mounting tracks) to move an electronic device, such as the mobile phone 250, between a first position directly behind the access door 106 and a second position between an upper chamber 230 and an opposing lower chamber 232. Moreover, in this embodiment the inspection plate 244 is transparent, or at least partially transparent (e.g., formed of glass, Plexiglas, etc.) to enable the mobile phone 250 to be photographed and/or otherwise optically evaluated from all, or at least most viewing angles (e.g., top, bottom, sides, etc.) using, e.g., one or more cameras, mirrors, etc. mounted to or otherwise associated with the upper and lower chambers 230 and 232. When the mobile phone 250 is in the second position, the upper chamber 230 can translate downwardly to generally enclose the mobile phone 250 between the upper chamber 230 and the lower chamber 232. The upper chamber 230 is operably coupled to a gate 238 that moves up and down in unison with the upper chamber 230. As noted above, in the illustrated embodiment the upper chamber 230 and/or the lower chamber 232 can include one or more cameras, magnification tools, scanners (e.g., bar code scanners, infrared scanners, etc.) or other imaging components (not shown) and an arrangement of mirrors (also not shown) to view, photograph and/or otherwise visually evaluate the mobile phone 250 from multiple perspectives. In some embodiments, one or more of the cameras and/or other imaging components discussed above can be movable to facilitate device evaluation. The inspection area 108 can also include weight scales, heat detectors, UV readers/detectors, and the like for further evaluation of electronic devices placed therein. The kiosk 100 can further include an angled binning plate 236 for directing electronic devices from the transparent plate 244 into a collection bin 234 positioned in a lower portion of the kiosk 100.

The kiosk 100 can used in a number of different ways to efficiently facilitate the recycling, selling and/or other processing of mobile phones and other consumer electronic devices. Referring to FIGS. 1-2D together, in one embodiment a user wishing to sell a used mobile phone, such as the mobile phone 250, approaches the kiosk 100 and identifies (via, e.g., a touch screen) the type of device the user wishes to sell in response to prompts on the display screen 104. Next, the user may be prompted to remove any cases, stickers, or other accessories from the device so that it can be accurately evaluated. Additionally, the kiosk 100 may print and dispense a unique identification label (e.g., a small adhesive-backed sticker with a QR code, barcode, etc.) from the label outlet 110 for the user to adhere to the back of the mobile phone 250. After this is done, the door 106 retracts allowing the user to place the mobile phone 250 onto the transparent plate 244 in the inspection area 108 of FIG. 2A. The door 106 then closes and the transparent plate 244 moves the phone 250 under the upper chamber 230 as shown in FIG. 2B. The upper chamber 230 then moves downwardly to generally enclose the mobile phone 250 between the upper and lower chambers 230 and 232, and the cameras and/or other imaging components in the upper and lower chambers 230 and 232 perform a visual inspection of the phone 250. In some embodiments, the visual inspection can include a 3D visual analysis to confirm the identification of the mobile phone 250 (e.g. make and model) and/or to evaluate or assess the condition and/or function of the phone 250 and/or its various components and systems. For example, the visual analysis can include an inspection of a display screen on the phone 250 for cracks or other damage. In some embodiments, the kiosk 100 can perform the visual analysis using one or more of the methods and/or systems described in detail in the commonly owned patents and patent applications identified herein and incorporated by reference in their entireties.

Referring next to FIG. 2C, after the visual analysis is performed and the device has been identified, the upper chamber 230 returns to its upper position and the transparent plate 244 returns the phone 250 to its initial position next to the door 106. The display screen 104 can also provide an estimated price or an estimated range of prices that the kiosk 100 may offer the user for the phone 250 based on the visual analysis and/or based on user input (e.g., input regarding the type, condition, etc. of the phone 250). If the user indicates (via, e.g., input via the touch screen) that he or she wishes to proceed with the transaction, the carrousel 240 automatically rotates an appropriate one of the connectors 242 into position adjacent the transparent plate 244, and door 106 is again opened. The user can then be instructed (via, e.g., the display screen 104) to withdraw the connector 242 (and its associated wire) from the carrousel 240, plug the connector 242 into the corresponding port (e.g., a USB port) on the phone 250, and reposition the phone 250 in the inspection area on the transparent plate 244. After doing so, the door 106 once again closes and the kiosk 100 performs an electrical inspection of the device to further evaluate the condition of the phone as well as specific component and operating parameters such as memory, carrier, etc. In some embodiments, the kiosk 100 can perform the electrical analysis using one or more of the methods and/or systems described in detail in the commonly owned patents and patent applications identified herein and incorporated by reference in their entireties.

After the visual and electronic analysis of the mobile phone 250, the user is presented with a phone purchase price via the display screen 104. If the user declines the price (via, e.g., the touch screen), a retraction mechanism (not shown) automatically disconnects the connector 242 from the phone 250, the door 106 opens, and the user can reach in and retrieve the phone 250. If the user accepts the price, the door 106 remains closed and the user may be prompted to place his or her identification (e.g., a driver's license) in the ID scanner 112 and provide a thumbprint via the biometric reader 114 (e.g., a fingerprint reader). As a fraud prevention measure, the kiosk 100 can be configured to transmit an image of the driver's license to a remote computer screen, and an operator at the remote computer can visually compare the picture (and/or other information) on the driver's license to the person standing in front of the kiosk 100 as viewed by one or more of the cameras 116a-c of FIG. 1 to confirm that the person attempting to sell the phone 250 is in fact the person identified by the driver's license. In some embodiments, one or more of the cameras 116a-c can be movable to facilitate viewing of kiosk users, as well as other individuals in the proximity of the kiosk 100. Additionally, the person's fingerprint can be checked against records of known fraud perpetrators. If either of these checks indicate that the person selling the phone presents a fraud risk, the transaction can be declined and the phone 250 returned. After the user's identity has been verified, the transparent plate 244 moves back toward the upper and lower chambers 230 and 232. As shown in FIG. 2D, however, when the upper chamber 230 is in the lower position the gate 238 permits the transparent plate 244 to slide underneath but not electronic devices carried thereon. As a result, the gate 238 knocks the phone 150 off of the transparent plate 244, onto the binning plate 236 and into the bin 234. The kiosk 100 can then provide payment of the purchase price to the user. In some embodiments, payment can be made in the form of cash dispensed from the cash outlet 118. In other embodiments, the user can receive remuneration for the mobile phone 150 in various other useful ways. For example, the user can be paid via a redeemable cash voucher, a coupon, an e-certificate, a prepaid card, a wired or wireless monetary deposit to an electronic account (e.g., a bank account, credit account, loyalty account, online commerce account, mobile wallet, etc.), Bitcoin, etc.

As those of ordinary skill in the art will appreciate, the foregoing routine is but one example of a way in which the kiosk 100 can be used to recycle or otherwise process consumer electronic devices such as mobile phones. Although the foregoing example is described in the context of mobile phones, it should be understood that kiosk 100 and various embodiments thereof can also be used in a similar manner for recycling virtually any consumer electronic device, such as MP3 players, tablet computers, laptop computers, e-readers, PDAs, Google® Glass™, smartwatches, and other portable or wearable devices, as well as other relatively non-portable electronic devices such as desktop computers, printers, televisions, DVRs, devices for playing games, entertainment or other digital media on CDs, DVDs, Blu-ray, etc. Moreover, although the foregoing example is described in the context of use by a consumer, the kiosk 100 in various embodiments thereof can similarly be used by others, such as store clerk, to assist consumers in recycling, selling, exchanging, etc. their electronic devices.

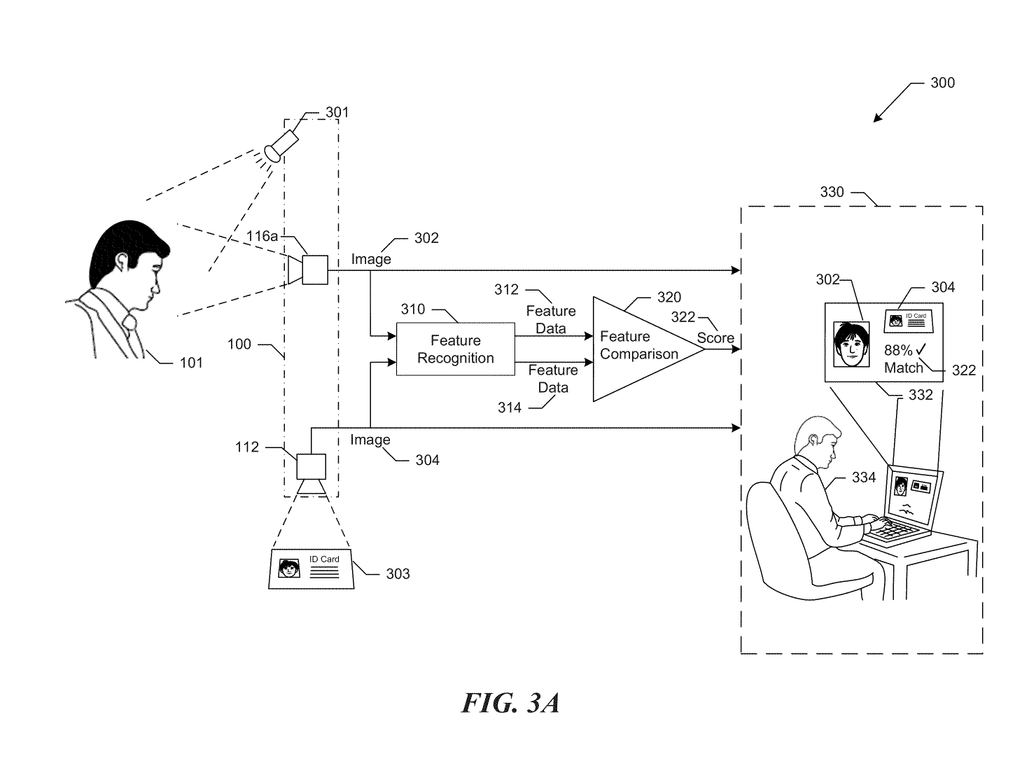

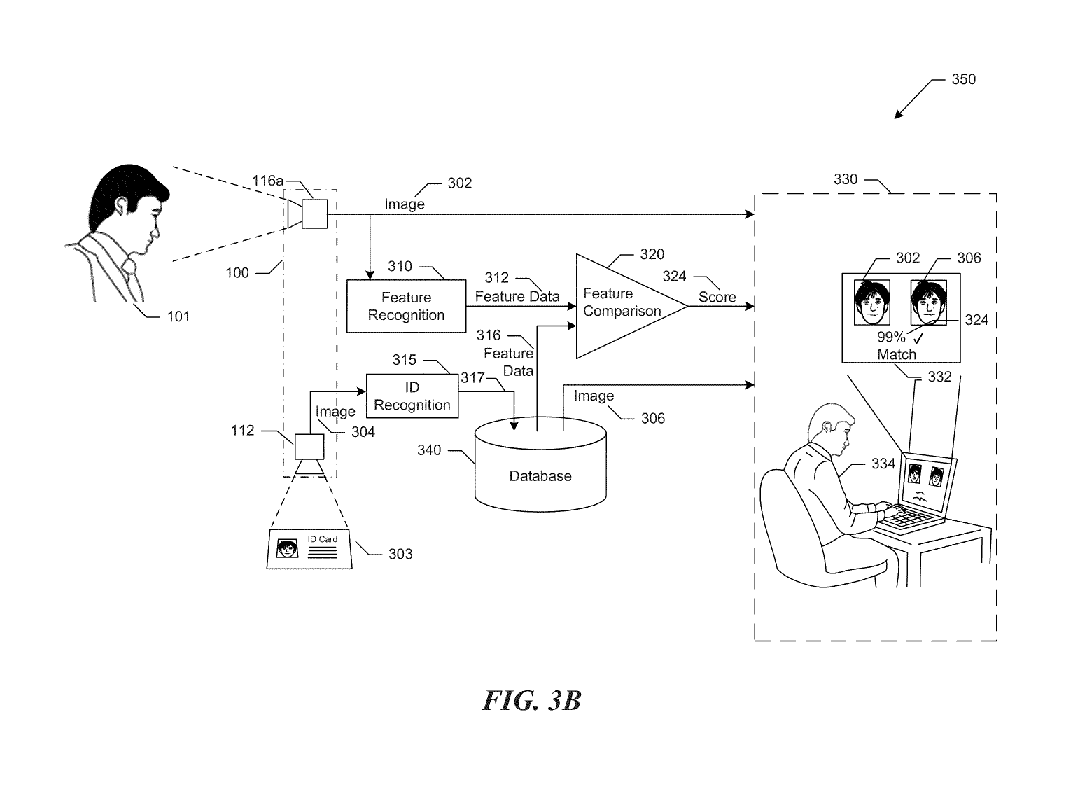

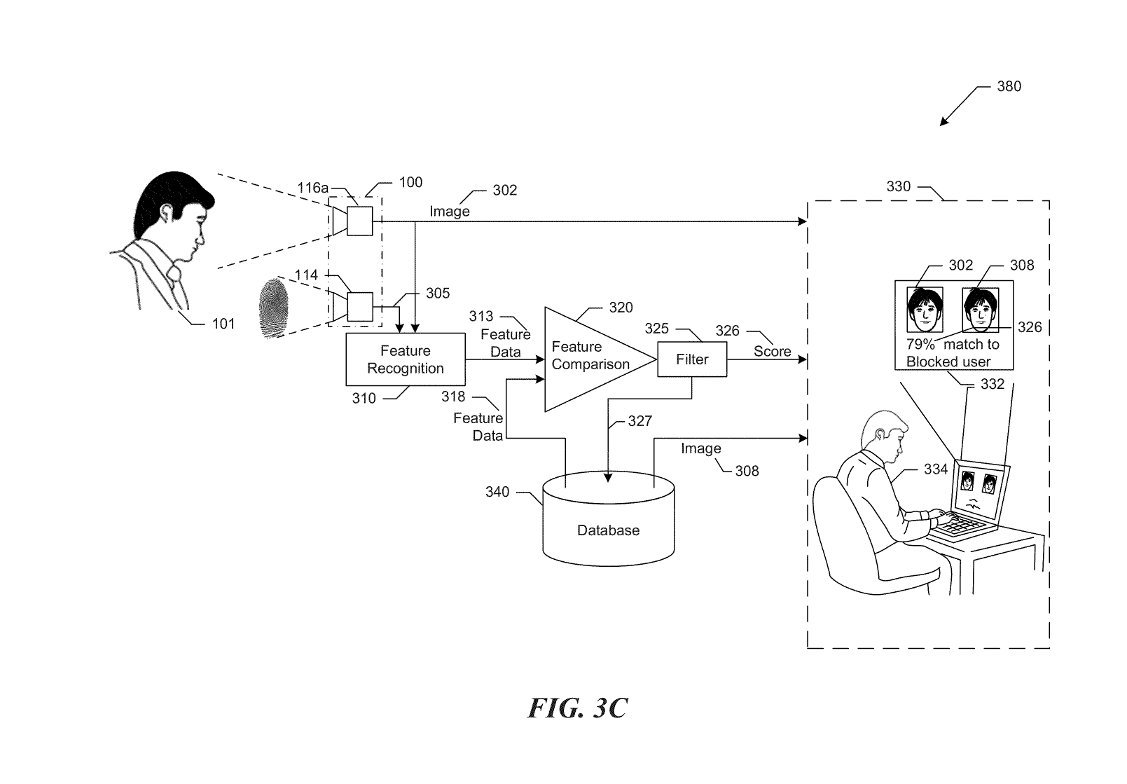

FIGS. 3A-3C are schematic diagrams illustrating kiosk user verification systems 300, 350, and 380, respectively, configured in accordance with embodiments of the present technology. In various embodiments, a kiosk (e.g., the kiosk 100 of FIG. 1) and/or one or more other processing devices operably connectable to the kiosk 100, such as a remote computer (e.g., a server), and/or an electronic device owned by a user (e.g., a mobile electronic device running an app for evaluating electronic devices) can include some or all of the components and implement some or all of the data flows depicted in FIGS. 3A-3C. Referring first to FIG. 3A, the verification system 300 includes a camera, such as one or more of the kiosk cameras 116 of FIG. 1 (e.g., the camera 116a), and an ID reader, such as the ID scanner 112 of FIG. 1. In some embodiments, the verification system 300 can also include a light source 301 such as a lightbulb (e.g., a fluorescent bulb, a momentary LED flash, and/or an infrared illumination array to ensure adequate lighting of the subject (e.g., the user 101 of FIG. 1). The light source 301 can be integrated into, for example, the header 120 of the kiosk 100, and/or mounted proximate to the camera 116a and directed toward the user's position in front of the kiosk 100.

In the illustrated embodiment, the verification system 300 also includes a feature recognition component 310 and a feature comparison component 320, which can be implemented as hardware and/or software systems. They can be located and implemented within the kiosk 100, and/or they can be situated remotely from the kiosk 100, such as within one or more server computers and/or cloud computing services. The feature recognition component 310 is configured to process images, such as photographs of the faces of kiosk users, and quantify features of the images (“feature data”), such as by generating numeric representations of features of the images. In some embodiments, the feature data directly describes facial features or contours that can be used for facial recognition, because the contours of a given user's face will presumably vary very little over relatively short periods of time (e.g., weeks or months). For example, once a person has reached adulthood, the width and height of the person's head and the positions of eyes, ears, etc. are typically fixed by bone structure. Thus, image feature data that represent facial contours, such as distance and angle measurements of the relative positions, shapes, and sizes of identifiable facial features, are generally consistent between photographs of the same person within relatively short periods of time. The feature recognition component 310 can detect facial features such as eyes (based on, e.g., identifying dark areas characteristic of pupils proximate to lighter areas characteristic of sclera), and then generate data in various forms to represent the detected facial features. For example, a vector can be represented as a matrix of beginning and ending points (x and y values on a Cartesian grid), or as angles and magnitudes (e.g., directions and distances between corners of the user's eyes and mouth). For example, the relative position of a user's eyes can be represented as one or more vectors describing the x-y coordinate positions of each eye in the image (e.g., pixel positions in a scaled and/or aligned image of the user's face), the distance and angle between the eyes and/or with respect to other facial contours, the percentage of the user's face above and below the eyes, etc.

In some embodiments, the feature recognition component 310 can generate one or more sets of image feature data that that do not require identifying individual facial features such as a nose. For example, the feature data can include image characteristics, such as the relative brightness or contrast of two or more image regions, that do not directly describe features of the user's face. The feature recognition component 310 can also generate feature data using, in addition to or instead of facial feature geometry, various approaches such as texture analysis, photometric stereo analysis, 3D analysis, etc. that would be familiar to a person of ordinary skill in the art. For example, the feature recognition component 310 can treat a photograph as a vector or matrix describing, e.g., the brightness of each pixel in the photo, and perform a statistical analysis of the values in the matrix. The feature recognition component 310 can then include results of the statistical analysis (e.g., a histogram of brightness values, a numeric result of a regression test, etc.) in the feature data. Thus, the feature data can directly or indirectly represent image features or characteristics in addition to or instead of facial features.

In some embodiments, feature data can describe a photo of a user's face as a mathematical combination of distinct components or facial types that differ from an “average” human face. One such approach, principal components analysis, generates feature data in the form of an expression that combines many different face-like images (“eigenfaces”) in various proportions. For example, the expression can be a linear combination (a weighted sum) of the average face and each of the different eigenfaces (e.g., 18% of eigenface 1+2.5% of eigenface 2+ . . . +−3% of eigenface n). When they are combined, the result closely approximates the photo of the user's face. The system can perform principal components analyses by taking a large number of face images (a “training set” of image vectors), averaging them all to get a mean (an average face image), subtracting the mean from each image, and then performing principal component analysis to obtain a set of orthogonal vectors (normalized eigenvectors of the face image vectors, thus, eigenfaces) that are uncorrelated to each other and represent the ways that the training set face images differ from the mean. Then, when a user is photographed at the kiosk 100, the feature recognition component 310 can generate feature data describing the photograph as a particular combination of the eigenfaces. The feature recognition component 310 can also utilize other statistical analysis approaches that would be familiar to a person of ordinary skill in the art, such as linear discriminant analysis (e.g., Fisherfaces), elastic matching, etc. to generate feature data.

The feature recognition component 310 can generate a large volume of feature data from an image, and then perform steps to reduce the volume of that data. In some embodiments, the feature recognition component 310 can take a large number of measurements of facial features (e.g., distances and/or angles between identifiable facial structures, alignments, textures, brightness values, etc.), such as approximately 10,000 to 100,000 measurements of the image, and then sample the image by various methods to generate a lower resolution matrix of values. For example, the feature recognition component 310 can apply a hash function to feature data to generate a compact representation of the feature data. In some embodiments, the feature recognition component 310 generates a relatively small volume of feature data based on a limited set of vectors, textures, or other measurements, such as those previously determined to be the most relevant feature data for distinguishing different individuals. Machine learning or other testing can determine the most statistically useful feature data by techniques well known to those of ordinary skill in the art. For example, feature data indicating the presence of a nose on a face would be of limited value, because having a nose is common; but feature data describing the particular shape, size, and position of the nose could be determined to be useful to distinguish different people.

In the illustrated embodiment, the feature comparison component 320 is configured to compare the feature data of two or more facial images and generate a rating, score, or other metric describing the level of similarity between the images. For example, where feature data includes facial contour measurements, the feature comparison component 320 can determine, e.g., whether some or all of the measurements from a first image (e.g., a real-time photograph of the user) match the measurements from a second image (e.g., a driver's license picture) within a certain margin of error (e.g., an amount of variance allowed based on measurement uncertainty). As another example, if the feature data are expressed as vectors, then the feature comparison component 320 can calculate the Euclidian distance (i.e., the shortest line) between the vectors and/or their endpoints; the smaller the distance, the higher the level of similarity. As yet another example, where image feature data is based on image statistics, the feature comparison component 320 can compare feature data from a first image to feature data from a second image to identify a degree of statistical similarity. The feature comparison component 320 can compare images using multiple approaches and generate one or more similarity scores 322 representing a probability that the images are of the same user.

In the illustrated embodiment, the verification system 300 also includes a verification facility 330. In the illustrated embodiment, the verification facility 330 is configured for use by an operator 334 to facilitate remote verification of the identity of the kiosk user 101. For example, the verification facility 330 can include an operator workstation including a computer terminal with a display screen 332. The display screen 332 can be configured to display images from the camera 116a and the ID scanner 112, as well as scores from the feature comparison component 320 for viewing by the operator 334. The verification facility 330 can also include one or more operator input devices such as a keyboard, mouse, microphone, etc. for receiving input from the operator 334, such as approval or denial of a transaction, entry of a subjective similarity score from the operator 334, and/or instructions to the user at the kiosk 100. For example, the operator 334 can type a message for the kiosk 100 to display to the user (e.g., on the display screen 104) or speak to the user via a microphone. For example, the operator 334 can ask the user to step in front of the kiosk 100 and face the camera 116a, remove a hat, re-scan the user's ID card, etc. In other embodiments, the verification facility 330 can be implemented as a hardware and/or software component configured for automated verification of user identity based on the scoring provided by the feature comparison component 320 and without the need for an operator 334 to perform or facilitate this process.

To verify the identity of the kiosk user 101 with the verification system 300 in accordance with one embodiment, the kiosk camera 116a captures an image 302 of the face of the user 101, and the ID scanner 112 captures an image 304 of the user's photo on an ID card (e.g., a driver's license 303 submitted by the user 101). The user image 302 and the ID photo image 304 are transmitted to the feature recognition component 310 and to the verification facility 330. The feature recognition component 310 processes the image 302 from the photograph of the user 101 and produces a first set of feature data 312. The feature recognition component 310 also processes the image 304 from the scan of the user's ID card 303 and produces a second set of analogous feature data 314.

The two sets of feature data 312 and 314 are then transmitted from the feature recognition component 310 to the feature comparison component 320. The feature comparison component 320 compares the two sets of feature data and generates a similarity score 322 that corresponds to or reflects the level of similarity between the photograph of the user's face taken by the camera 116a and the photograph of the picture of the user's face on the user's ID card 303 taken by the ID scanner 112. The probability score can be, for example, a value between zero and one, representing the likelihood that the subject of the current photograph(s), i.e., the user 101, is the cardholder pictured on the ID card 303. For example, the sets of feature data 312 and 314 can include information about the ratio of the height of the user's face to the width of the user's face in the user photograph image 302 and the ID card image 304, respectively. In this embodiment, the closer the two ratios are to each other (i.e., the more closely the feature data match each other), the higher the similarity score 322, if all other factors are held equal. In some embodiments, the comparison component 320 generates an overall similarity score 322 based on a plurality of similarity measurements that each reflect a different aspect of similarity between the photographs. For example, in one embodiment the comparison component 320 can generate one similarity score based on facial feature geometry and another similarity score based on texture analysis and combine or aggregate them, such as by taking a weighted or unweighted mean, median, minimum or maximum value, etc. The resulting similarity score 322 is then transmitted to the verification facility 330. The verification facility 330 receives the image 302 of the user 101 captured by the kiosk camera 116a, the image 304 of the user's ID card 303 captured by the ID scanner 112, and the feature comparison similarity score 322.

In the illustrated embodiment, the similarity score 322 is displayed for the operator 334 on the display screen 332 of the verification facility 330, along with the user photograph image 302 and the ID card picture image 304. To verify that the user 101 is in fact the cardholder shown on the ID card 303, the operator 334 can visually compare the user photograph image 302 to the ID photo image 304 (and/or the description of the user provided on the ID card 303, e.g., sex, height, weight, eye color, etc.), and make an assessment of the accuracy of the match. The operator 334 can also send a written message for display via the display screen 104 and/or an audio message for broadcast via a speaker on the kiosk 100 prompting the user 101 to turn to face the camera 116a, remove glasses, unblock the camera 116a, etc., if additional perspectives or photographs are needed. In one aspect of the present technology, this subjective process can be advantageously augmented by availing the operator 334 of the similarity score 322. For example, the similarity score 322 can be based on measurements of fixed physical features (e.g., nose shape, interpupillary distance, etc.) and can ignore cosmetic features that might throw off a human reviewer, such as the operator 334. For example, the operator 334 might not initially recognize a valid user who has dyed her hair a different color, but a high similarity score can indicate to the operator 334 that the user's face in the image 302 from her user photograph is a close match to the face in the image 304 from her ID card picture. As another example, the operator 334 might be inclined to accept a user 101 who superficially resembles the image 304 from the driver's license 303, but if measurements such as eye spacing do not match, a low similarity score 322 can alert the operator 334 that the user 101 is a poor match, thereby suggesting that the user 101 should be prevented from using the kiosk 100. In the illustrated embodiment, the present technology supplements the ability of the operator 334 to compare a kiosk user's photographic image 302 to the user's ID photo image 304, by generating the similarity score 322 assessing the quality of the match and displaying the similarity score 322 along with the images 302 and 304 on the display screen 332. Accordingly, the present technology can enhance the accuracy of the user identification process, thus increasing confidence that electronic devices are recycled by their legitimate, identified owners, and reducing potential losses from devices submitted by dishonest, unidentified individuals.

Turning next to FIG. 3B, the verification system 350 includes many features of the verification system 300 described above. For example, the verification system 350 includes the kiosk camera 116a, the ID scanner 112, the feature recognition component 310, the feature comparison component 320, and the verification facility 330. In one aspect of the illustrated embodiment, however, the verification system 350 further includes an ID recognition component 315 and one or more databases 340. The ID recognition component 315 and the database 340 can be included and implemented as hardware and/or software components within the kiosk 100 and/or one or both can be remotely situated. For example, the database 340 can include one or more data structures hosted within the kiosk 100, and/or one or more remote data facilities, such as a database, operably connected to a server or data storage hosted by a cloud computing service. The database 340 can contain stored images (e.g., images of faces of known users) and/or feature data (e.g., dimensional, geometrical, photometric, etc. information about facial features and/or photograph characteristics) associated with the known users. The database 340 can also contain other information (e.g., associated user name, height, weight, sex, ID number, account information, etc.) associated with the known users. Such known users can include, for example, the user 101. In some embodiments, the database 340 can be implemented as a remotely hosted master database that incorporates user information received from a plurality of kiosks in a network of kiosks, and a local database maintained by the kiosk 100. The master database and the local database can be periodically synchronized by uploading information about new users at the kiosk 100 from the local database to the master database, and downloading information about other users at other kiosks from the master database to the local database.

The ID recognition component 315 is configured to analyze an image 304 of an ID card (e.g., the driver's license 303) to obtain information that can identify the cardholder (e.g., name, sex, birthdate, etc.), and then determine whether the database 340 contains information (e.g., photographs and/or feature data) associated with the cardholder. For example, the ID recognition component 315 can be configured to scan the ID card image 304 for text such as the cardholder's name, a unique driver's license number, and/or a combination of data about the cardholder displayed or otherwise encoded on the ID card 303. In some embodiments, the ID recognition component 315 can utilize optical character recognition (OCR) techniques to convert portions of the ID image 304 to text. The ID recognition component 315 can also decode data encoded in a visual barcode such as a 1D or 2D barcode or a QR code. Those of ordinary skill in the relevant art understand such OCR and barcode decoding techniques. In other embodiments, the ID recognition component 315 can also receive data encoded on, e.g., a magnetic stripe, radio-frequency chip, or other format, and read from the ID card 303 by a suitable reader, such as the scanner 112. The ID recognition component 315 produces an identifier 317 (e.g., an alphanumeric string, a numeric identifier, or a set of multiple data fields) that identifies the cardholder of the ID card 303. For example, the ID recognition component 315 can use one or more of the name, birthday, biometric information, and/or card number (e.g., driver's license number) on the ID card 303 to identify the cardholder. The ID recognition component 315 can also generate an identifier 317 such as a cryptographic hash value based on the information displayed on the ID card 303 to uniquely identify the cardholder.

To verify the identity of the kiosk user 101 with the verification system 350 in accordance with one embodiment, the kiosk camera 116a captures an image of the user's face, such as the user image 302. The user image 302 is transmitted to the feature recognition component 310 and to the verification facility 330. The feature recognition component 310 analyzes the user image 302 and generates a set of feature data based on the image, such as the feature data 312. For example, in some embodiments the feature recognition component 310 can identify and measure the relative locations of key facial structures, and/or generate a linear expression describing the user image 302 as a weighted combination of various eigenfaces, as described above with reference to FIG. 3A. The set of feature data 312 is then transmitted from the feature recognition component 310 to the feature comparison component 320.

Additionally, the ID scanner 112 captures an image 304 of the user's ID card (e.g., a driver's license 303 submitted by the user 101). The ID card image 304 is transmitted to the ID recognition component 315. The ID recognition component 315 processes the image 304 from the scan of the user's ID card 303 and produces information such as the string or numeric identifier 317 that identifies the cardholder of the ID card 303. The ID recognition component 315 then transmits the identifier 317 to the database 340. For example, the ID recognition component 315 can send a query string to the database 340 to retrieve information in the database 340 associated with the user specified by the identifier 317. In response to receiving the identifier 317, the database 340 checks to see if it contains any information about the user, and if so, the database 340 provides an image 306 of the specified user and a set of feature data 316 associated with the identified user. For example, the database 340 can provide a photograph of the user 101 previously taken by the kiosk 100 (e.g., from an earlier visit to the kiosk 100 when the remote operator 334 of FIG. 3A verified the identity of the user 101), information from the user's driver's license, etc. The database transmits the image 306 of the specified user to the verification facility 330, and transmits the set of feature data 316 associated with the identified user to the feature comparison component 320.

The feature comparison component 320 compares the two sets of feature data 312 and 316, and generates a similarity score 324 that indicates a level of similarity between the photographic image of the user's face taken by the camera 116a and the stored photograph of the user's face retrieved from the database 340, as described above with reference to FIG. 3A. In some embodiments, the comparison component 320 can be configured to use different criteria to score the similarity of the sets of feature data 312 and 316 than the verification system 300 of Figure A uses to score the similarity of the two sets of feature data 312 and 314. For example, the current photograph image 302 and the saved photograph image 306—both taken by the kiosk 100 camera 116a—can be expected to be more similar to each other in some respects than the current photograph image 302 and a picture from a driver's license 303 taken by a different camera (e.g., in different lighting, from a different angle, etc.) and scanned by the ID scanner 112. Accordingly, the comparison component 320 can be configured to generate a similarity score 324 that requires a closer match between the two sets of feature data 312 and 316 than the verification system 300 of FIG. 3A would require between the sets of feature data 312 and 314. The feature comparison component 320 then transmits the resulting similarity score 324 to the verification facility 330.

The verification facility 330 receives the current image 302 of the user 101 photographed by the kiosk camera 116a, the stored image 306 of a known user retrieved from the database 340 in response to the identifier 317 of the cardholder, and the feature comparison similarity score 324. In the illustrated embodiment, the display screen 332 of the verification facility 330 displays the similarity score 324 for the operator 334, along with the current user photograph image 302 and the stored user photograph image 306. To verify that the user 101 is in fact a known user who has previously been photographed at the kiosk 100, the operator 334 can visually compare the user image 302 to the known user image 306 (or communicate with the user 101 have the user reposition herself to obtain a better photographic image 302 of the user 101). The operator can then subjectively assess the accuracy of the match based on the images 302 and 306 and the similarity score 324, as described above with reference to FIG. 3A, and decide whether to verify the user's identity and allow the user 101 to proceed with a transaction at the kiosk.

In one aspect of the present technology, providing the calculated similarity score 324 to the operator 334 can advantageously supplement the operator's subjective verification of the user's identity. For example, the user 101 may be a return customer who has previously completed successful transactions at the kiosk 100. If the user has superficially changed in appearance between photographs at the kiosk 100—due to, e.g., a haircut or different lighting at different times of day—the human operator 334 may be inclined to reject the user's image 302 as not matching the stored image 306; but a high similarity score 324 can show the operator 334 that the user is in fact very likely to be the same person and should be approved. Because the verification system 350 can compare a current photograph of the user 101 to a previous photograph taken at the kiosk 100 under similar conditions, it can produce a similarity score 324 more precise than a similarity score based on comparing dissimilar images, such as the similarity score 322 of the verification system 300 of FIG. 3A.

Turning next to FIG. 3C, the verification system 380 includes many features of the verification systems 300 and 350 described above. For example, the verification system 380 includes the kiosk camera 116a, the feature recognition component 310, the feature comparison component 320, the database 340, and the verification facility 330. In one aspect of the illustrated embodiment, however, the verification system 380 further includes a biometric reader, such as the biometric reader 114 of the kiosk 100 of FIG. 1 (e.g., a fingerprint reader). For example, the biometric reader 114 can capture a biometric identifier or biometric information about the user 101, such as an image of a fingerprint of the user 101 or a scan of the iris of the user's eye. In another aspect of the illustrated embodiment, the verification system 380 further includes a filter component 325 configured to filter out low quality matches. For example, the filter component 325 can receive one or more similarity scores indicating a level of similarity between two images, evaluate whether the similarity score(s) are above or below a preset threshold, and then only send the two images to the verification facility 330 for display to the remote operator 334 if the similarity score(s) are above the threshold. The filter component 325 can be included and implemented as hardware and/or software components within the kiosk 100 and/or it can be remotely situated.

In one aspect of the illustrated embodiment, the database 340 is a database of information about users including users on a do-not-buy list who have been blocked from use of the kiosk 100. Such “blocked” users are known users who should not be allowed to use the kiosk 100 because of, for example, past fraudulent behavior. Users could be placed on the blocked users list because, for example, they sold a device at the kiosk 100 that turned out to be stolen, or they attempted to recycle and sell a fake device. The database 340 can be implemented as a remotely hosted master do-not-buy list, and a local copy of the list maintained by the kiosk 100. The master do-not-buy list and the local list can be periodically synchronized.

To determine whether the kiosk user 101 is a blocked user in accordance with one embodiment of the verification system 380, the kiosk camera 116a captures an image of the user's face, such as the user image 302. The user image 302 is transmitted to the feature recognition component 310 and the verification facility 330. In the alternative and/or in addition, the biometric reader 114 can capture a biometric image 305 of a fingerprint (e.g., a thumbprint) of the user 101, and/or another biometric identifier of the user 101, such as a scan of the iris of one of the user's eyes. The feature recognition component 310 analyzes the user image 302 and/or the biometric image 305 and generates a set of feature data 313 based on the image(s), similar to the way the feature data 312 generated as described above with reference to FIG. 3A. The set of feature data 313 is then transmitted from the feature recognition component 310 to the feature comparison component 320. In response to a control signal (not shown) sent once the user 101 has come to the kiosk and/or indicated interest in a transaction, thereby starting a process to verify that the user 101 is not a blocked user, the database 340 also retrieves feature data 318 associated with one or more users who are classified as blocked users, such as a set of feature data 318 for each blocked user. Each set of feature data 318 associated with a blocked user is transmitted from the database 340 to the feature comparison component 320.

For each set of feature data 318 associated with a blocked user, the feature comparison component 320 compares the set of feature data 318 to the set of feature data 313 associated with the kiosk user 101, and generates a similarity score 326. The filter component 325 evaluates whether the similarity score 326 for each comparison is above or below a threshold, and determines whether the user 101 resembles a blocked user to a sufficient extent that the potential match should be presented for review by the operator 334. For example, it could be unreasonably time-consuming for the operator 334 to review comparisons of the user image 302 (and/or the biometric image 305) to every image associated with a blocked user, especially if the database 340 contains information about a large number of blocked users who do not resemble the user 101. Accordingly, if the filter component 325 determines, based on the similarity score 326 and the threshold, that the user 101 bears relatively little resemblance to a particular blocked user, then the filter component 325 disregards that blocked user and does not present information about that blocked user to the operator 334.

Conversely, if the filter component 325 determines that the sets of feature data 313 and 318 exceed a threshold level of similarity (e.g., if the user 101 closely resembles a blocked user), then the filter component 325 permits the similarity score 326 to be transmitted to the verification facility 330 for review by the operator 334. The filter component 325 also transmits an identifier 327 to the database 340 that causes the database 340 to transmit an image 308 of the blocked user associated with the similarity score 326 to the verification facility 330. For example, the filter component 325 can send a query to the database 340 to retrieve a photograph in the database 340 associated with the blocked user specified by the identifier 327. In the illustrated embodiment, the database produces an image 308 of the specific blocked user, such as a photograph of the blocked user previously taken by the kiosk 100 (e.g., from an earlier visit to the kiosk 100 when the blocked user attempted a fraudulent transaction). The database then transmits the image 308 of the blocked user to the verification facility 330. In some instances, the user 101 may resemble more than one blocked user. In some embodiments, the verification system 380 can transmit a plurality of blocked user images 308 to the verification facility 330 for review serially and/or in parallel (e.g., multiple simultaneous comparisons). In some embodiments, the images 302 and 308 are or include images of user fingerprints in addition to or instead of photographs of user faces.

The verification facility 330 receives the image 302 captured by the kiosk camera 116, the image(s) 308 from the database 340, and the feature comparison similarity score 326. In one aspect of the present technology, the user 101 may be a person on a do-not-buy list who is supposed to be blocked from use of the kiosk 100, e.g., as a result of previously having attempted or carried out a fraudulent transaction at the kiosk 100. The user 101 may try to alter his or her appearance to avoid being blocked from subsequent use of the kiosk 100 and thus attempt another fraudulent transaction. Even if the human operator 334 might not recognize the blocked user 101, the similarity score 326 can highlight the user's resemblance to a known blocked user, prompting the operator 334 to correctly reject the transaction. Accordingly, the present technology can enhance the accuracy of the user identification process and reduce vulnerability to repeated fraudulent transactions.

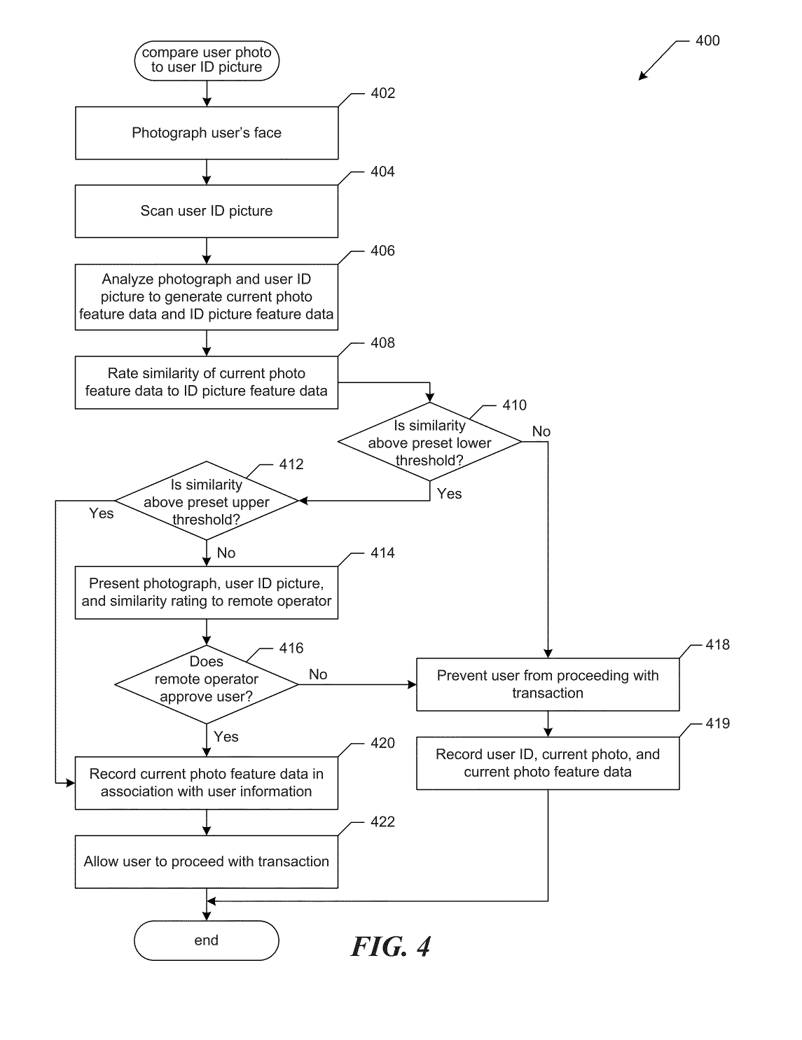

FIG. 4 is a flow diagram of a routine 400 for verifying the identity of a user, such as a consumer-operated kiosk user, in accordance with an embodiment of the present technology. In various embodiments, a kiosk (e.g., the kiosk 100 of FIG. 1) and/or one or more other processing devices operably connectable to the kiosk 100, such as a remote computer (e.g., a server) can perform some or all of the routine 400. The routine 400 utilizes facial recognition hardware and/or software to augment or replace a human reviewer's “judgment call” in confirming the identity of a consumer using the kiosk 100, such as the user 101 of FIG. 1. For example, in various embodiments the routine 400 compares an image of a photograph on a user's ID (e.g., an image of a driver's license photo) to a photograph of the user 101 standing in front of the kiosk 100. The routine 400 can produce a score or rating indicating a level of confidence that the user 101 standing in front of the kiosk is in fact the same person whose photo is on the driver's license. The routine 400 can make an automated decision based on the score, or can provide the score to a remote operator who can use it to help decide whether the user 101 is the person shown on the ID, and therefore whether the user 101 should be allowed to use the kiosk 100.

In block 402, the routine 400 photographs the user 101 with, for example, the camera 116a. In some embodiments, the routine 400 can take multiple photographs of the user's face, such as a series of photographs and/or video from one of the cameras 116; and/or photographs from more than one of the cameras 116a-c of FIG. 1, thereby providing multiple views (e.g., different angles and/or different focal length perspectives) of the user's face. In some embodiments, the routine 400 uses depth sensors and/or stereoscopic vision to obtain 3D measurements of the user's face. In block 404, the routine 400 scans the user's ID picture to obtain an image of the ID picture. For example, the kiosk 100 can prompt the user 101 to submit a piece of photo identification, such as an ID card (e.g., the driver's license 303 of FIG. 3). The ID scanner 112 can scan or photograph the entire driver's license 303, and/or identify (e.g., crop) a portion of the driver's license 303 that contains a picture of the user's face.

In block 406, the routine 400 analyzes at least one of the current photographs of the user to generate feature data corresponding to the current photograph, and analyzes the ID picture image to generate feature data corresponding to the scanned ID picture. In some embodiments, the routine 400 processes the image of the user's face from the current photograph and the image of the user's face in the ID picture, and generates respective feature data as a vector or a series of vectors, as described in detail above with reference to FIG. 3A. For example, each pixel in the image of the user's face can be treated as a single brightness value (or, e.g., a set of RGB values) so that the entire image is represented as a single multi-dimensional vector or matrix of those values.

In block 408, the routine 400 compares the feature data from the current user photograph to the feature data from the user's ID picture, such as described above with reference to the feature comparison component 320 of the verification system 300 of FIG. 3A. Based on that comparison, the routine 400 rates the level of similarity of the current photograph feature data to the ID picture feature data, such as by generating the similarity score 322 described above with reference to FIG. 3A.

In some embodiments, the routine 400 can make authentication decisions automatically based on the level of similarity. In decision block 410, for example, the routine 400 determines whether the level of similarity between the current photograph feature data and the ID picture feature data is above a preset lower threshold. The lower threshold could be, for example, a 20% level of similarity. If the level of similarity between the current photograph feature data and the ID picture feature data is below the lower threshold, e.g., 18% then the routine 400 proceeds to block 418, preventing the user 101 from proceeding with the transaction. For example, the current photograph of the user 101 may bear little resemblance to the ID picture, such as if the user 101 submits false identification, e.g., a driver's license 303 belonging to someone else. If the similarity score does not pass the preset lower threshold, indicating that the user 101 at the kiosk is clearly not the same person as shown on the driver's license 303, then the routine 400 rejects the user 101 without requiring human review of the clear mismatch. On the other hand, if the level of similarity is above the lower threshold, then the routine 400 proceeds to decision block 412. In decision block 412, the routine 400 determines whether the level of similarity between the current photograph feature data and the ID picture feature data is above a preset upper threshold. The upper threshold could be, for example, a 90% level of similarity. If the level of similarity is above the upper threshold, then the routine 400 proceeds to block 420 and automatically approves the user 101 to proceed with the transaction. For example, the current photograph of the user 101 may closely resemble the user's photo identification picture. In such an instance, the similarity score generated in block 408 could indicate, e.g., a 92% level of similarity between the current photograph feature data and the ID picture feature data. If that level of similarity equals or exceeds the preset upper threshold, then the routine 400 automatically approves the user 101 as matching the submitted photo ID picture. On the other hand, if the level of similarity is not above the upper threshold, then the routine 400 proceeds to block 414 for verification by a remote operator. In other embodiments, the routine 400 bypasses block 410 and/or block 412 to ensure that a remote operator makes or reviews all decisions to approve the user 101.

In block 414, the routine 400 presents the current photograph of the user, the scanned image of the user ID picture, and the similarity score for display to a remote operator for verification of the user's identity. For example, the routine 400 can present a cue or recommendation to the remote operator (e.g., the remote operator 334 of FIG. 3A) regarding how to act on the user identification (e.g., “High match confidence”, “The ID does not appear to match”, or “Perfect match”), based on the similarity rating. The rating and/or recommendation can then be used by the remote human operator 334 to supplement the human operator's determination as to the identity of the user. For example, in some embodiments, the similarity score is combined with the human operator's subjective rating to determine a composite rating of the likelihood that the user is authentic, and then the composite rating can be compared to a pass/fail criteria to determine whether or not to authenticate the user. In various embodiments, the pass/fail criteria can be based on a sliding scale. For example, the policy might be to verify a user's identity if the routine 400 determines a similarity score above, for example, 80%, and the human operator assigns a similarity score above, for example, 50%. In this example, a user would be verified if the routine 400 determined that there is an 87% likelihood that the user is the cardholder and the human operator was only 60% sure.

If the remote operator does not approve the user 101 in decision block 416, then the routine 400 proceeds to block 418. In some embodiments, the routine 400 partly or completely automates the decision of whether the user matches the submitted identification. For example, if the routine 400 includes a composite rating of the likelihood that the user is authentic as described above, and if the composite rating for the user 101 fails the pass/fail criteria, then the routine 400 proceeds to block 418. In block 418, the routine 400 prohibits the user 101 from proceeding with a transaction at the kiosk 100. For example, the kiosk 100 can return any electronic device submitted by the user 101, and present a message on the display screen 104 informing the user 101 that the kiosk 100 cannot accept electronic devices from him or her unless the user 101 presents valid photo identification. In block 419, the routine 400 can record information about the user. For example, the routine 400 can save the user photograph and associated feature data and/or the image of the ID picture, so that if the same user returns to the kiosk or if someone uses that ID card again at the kiosk, the verification system can alert the remote operator about the previous failed ID verification. After block 419, the routine 400 ends.

Returning to decision block 412 or decision block 416, if the user 101 is approved as matching his or her ID picture (e.g., if the remote operator approves the user 101), then the routine 400 proceeds to block 420. In block 420, the routine 400 records the current user photograph(s), the current photo feature data, and the user identification information in a database (e.g., the database 340 of FIG. 3B), so that this information can be accessed if the user 101 returns to use the kiosk 100 or another kiosk in the future. In block 422, the routine 400 allows the user 101 to proceed with a transaction at the kiosk 100. After block 422, the routine 400 ends.

The present technology enables kiosk ID verification to be based on physical features (e.g., chin shape, eye spacing, etc.) or other objective photographic feature data rather than cosmetic attributes (e.g., hair color, style, facial hair, etc.) that might throw off a human reviewer. Accordingly, the augmented review process of the present technology can enhance the accuracy of the user identification process and reduce fraud. In one aspect of the present technology, automated rejection or approval of a user based on scoring a level of similarity between a current photograph and an ID picture can enable automatic verification of a user's identity without human intervention, such as without review by a remotely located human operator 334 of FIG. 3A. Accordingly, the present technology can increase efficiency by reducing labor costs, avoiding human error, adding consistency, and reducing verification delays that might occur with other verification systems.

FIG. 4 and the flow diagrams that follow are representative and may not show all functions or exchanges of data, but instead they provide an understanding of commands and data exchanged under the system. Those skilled in the relevant art will recognize that some functions or exchange of commands and data may be repeated, varied, omitted, or supplemented, and other (less important) aspects not shown may be readily implemented. Those of ordinary skill in the art will appreciate that the blocks shown in FIG. 4 and in the other flow diagrams described herein may be altered in a variety of ways. For example, while processes or blocks are presented in a given order, alternative implementations may perform routines in a different order, and some processes or blocks may be rearranged, deleted, moved, added, subdivided, combined, and/or modified to provide alternative or sub-combinations. Each of these processes or blocks may be implemented in a variety of different ways. Also, although processes or blocks are at times shown as being performed in series, these processes or blocks may instead be performed or implemented in parallel, or may be performed at different times. Some of the blocks depicted in FIG. 4 and the other flow diagrams are of a type well known in the art, and can themselves include a sequence of operations that need not be described herein. Those of ordinary skill in the art can create source code and/or microcode, program logic arrays, or otherwise implement the invention based on the flow diagrams and the detailed description provided herein.

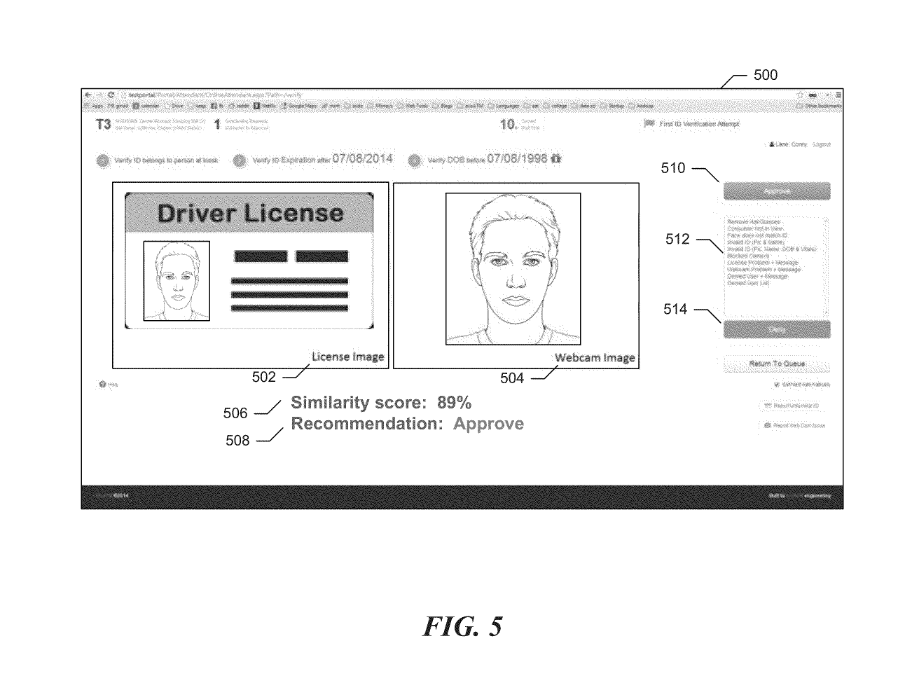

FIG. 5 illustrates a display page 500 for facilitating remote ID verification in accordance with an embodiment of the present technology. In some embodiments, the display screen 332 of the verification facility 330 of FIG. 3A can present the display page 500 and/or portions thereof. The display page 500 can provide cues to a an online attendant or other remote operator (e.g., the remote operator 334) that can promote higher quality visual verification of user identity, such as by prompting the remote operator to take a closer look at ID matches that have low similarity scores. The similarity score can speed up verification and improve verification accuracy, reducing the labor cost of remote operators and reducing wait times for kiosk consumers.

The display page 500 includes an image 502 of the user's driver's license and an image 504 of the user present in front of the kiosk. In some embodiments, the image 504 can include multiple views and/or video footage of the user. The page 500 can also include a confidence or similarity score 506 based on an automated comparison of the images facilitated by facial recognition technology as described above, and a recommendation 508 based on the similarity score 506. In the illustrated example, the image 504 of the user matches the driver license image 502 with a similarity score 506 of 89%. As a result, the recommendation 508 is to approve the match and allow the user to proceed with the transaction. The display page 500 includes interface buttons or other input features enabling the remote operator to approve the match via an approve button 510, or to reject the match via a deny button 514 and/or to provide one or more standard messages 512 to the user. In some embodiments, the remote operator can edit the message 512, for example, to explain a reason for rejection and/or to request that the user take some action such as removing a hat or sunglasses.

The display pages, graphical user interfaces, or other screen displays described in the present disclosure, including the display page 500, illustrate representative computer display screens or web pages that can be implemented in various ways, such as in C++ or as web pages in Extensible Markup Language (XML), HyperText Markup Language (HTML), the Wireless Access Protocol (WAP), LaTeX or PDF documents, or any other scripts or methods of creating displayable data, such as text, images, animations, video and audio, etc. The screens or web pages provide facilities to present information and receive input data, such as a form or page with fields to be filled in, pull-down menus or entries allowing one or more of several options to be selected, buttons, sliders, hypertext links or other known user interface tools for receiving user input. While certain ways of displaying information to users are shown and described with reference to certain Figures, those skilled in the relevant art will recognize that various other alternatives may be employed. The terms “screen,” “web page” and “page” are generally used interchangeably herein.

When implemented as web pages, for example, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database typically connected to a server. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), matrix or bit-mapped formats, animated or video formats, etc. While aspects of the invention are described herein using a networked environment, some or all features can be implemented within a single-computer environment.

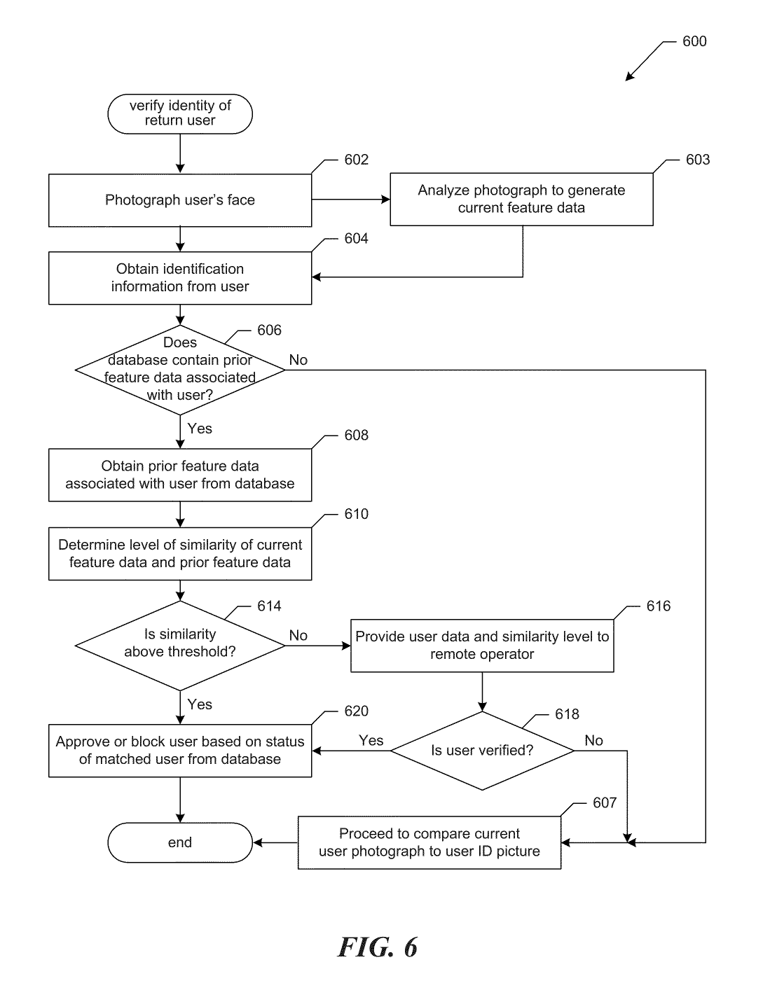

FIG. 6 is a flow diagram of a routine 600 for verifying the identity of a return kiosk user in accordance with an embodiment of the present technology. In various embodiments, the kiosk 100 and/or one or more remote servers operably connectable to the kiosk 100 can perform some or all of the routine 600. The routine 600 enables the kiosk 100 to automatically verify return customers. For example, when a customer whose identity has previously been verified (e.g., by the remote operator 334 of FIG. 3A) returns to the kiosk 100, the routine 600 can allow that customer to bypass the verification process if the customer presents the same ID information and his or her face is a sufficient match to the face recorded against that ID information in connection with a previous transaction. In some embodiments, the routine 600 can also match photographs of the user's fingerprint in addition to or instead of the user's facial features. As another example, if a thief steals a phone and wallet (including an ID card) from someone who has previously used a kiosk 100, and then tries to sell the phone at a kiosk 100 using the stolen ID card, the kiosk 100 can implement the routine 600 to determine that the thief's face does not match the user's face previously associated with the ID card, and can block the transaction (while at the same time obtaining a photo of the thief that can be stored in a database of people to block from use of the kiosk 100, and/or provided to authorities such as mall security personnel or law enforcement).

In block 602, the routine 600 begins by photographing the user, as described above with reference to block 402 of FIG. 4. Next, in block 603, the routine 600 analyzes the photograph or photographs to generate feature data corresponding to the current photograph, as described above with reference to block 406 of FIG. 4. In block 604, the routine 600 obtains identification information from the user 101. For example, by scanning the user's driver's license 303 via the ID scanner 112, the routine 600 (e.g., the ID recognition component of FIG. 3B) can obtain the user's name and unique identification information such as a driver's license number and/or a combination of the user's name, address, and biographic information (e.g., age, height, sex, eye color, hair color, etc.).

In decision block 606, the routine 600 determines whether a database, such as the database 340 of FIG. 3B, contains any feature data that was previously associated with the user 101 identified by the identification information. For example, the routine 600 can generate an identifier such as the identifier 317 of FIG. 3B based on the identification information and then query a local database of the kiosk 100 and/or a remote database to determine whether the user 101 is a repeat customer who has previously been photographed at a kiosk. If no feature data associated with the user exists in the databases, such as would be the case for a first time user of the kiosk 100, then the routine 600 proceeds to block 607. In block 607, the routine 600 proceeds to compare the current photograph(s) of the user taken in block 602 to a user identification picture, such as described above with reference to FIG. 4. After block 607, the routine 600 ends. Returning to decision block 606, however, if feature data has previously been associated with the user's ID, then the routine 600 proceeds from decision block 606 to block 608.

In block 608, the routine 600 obtains prior feature data associated with the user's identification information from the database. For example, the routine 600 can look up prior feature data in a data structure indexed by the unique identifier 317. In some embodiments, for example, the routine 600 can retrieve one or more photographs of the user along with feature data that was previously generated from the one or more photographs and stored in the database. In other embodiments, the routine 600 can retrieve one or more photographs of the user and then generate feature data from the one or more photographs.

In block 610, the routine 600 determines a level of similarity of the current feature data and the prior feature data by comparing the current feature data generated in block 603 to the prior feature data obtained in block 608. For example, the routine 600 can assign a probability score, such as a value between zero and one, representing the likelihood that the user photographed in block 602 is the same user whose photograph(s) were retrieved from the database, i.e., the identified user. The resulting score indicates whether the user at the kiosk 100 is the same user who was previously photographed and whose identity was verified in association with the submitted identification information.

In decision block 614, the routine 600 determines whether the level of similarity between the feature data generated from the current photograph of the user's face and the previously recorded feature data is above a preset threshold. If the level of similarity is not above the threshold, then the routine 600 proceeds to block 616 and provides the similarity score and the user's data (including, e.g., the information from the user's ID card, the current photo of the user 101 at the kiosk, and the previously saved image of the user associated with the ID card) to the remote operator. For example, the routine 600 can display the information and/or an action recommendation on a verification station computer screen, such as the screen 332 described above with reference to FIG. 3B. The remote operator can review the information to determine whether he or she disagrees with the conclusion of the computer-implemented verification process based on the operator's real-time assessment of the user. In decision block 618, if the remote operator determines that the current photograph of the user sufficiently matches the prior photograph, then the routine 600 proceeds to block 620. Otherwise, the routine 600 proceeds to block 607.

Returning to decision block 614, if the level of similarity is above the threshold, then the routine 600 proceeds to block 620. For example, the user 101 may be a return customer whose current photograph closely resembles his or her prior photograph. In such an instance, the similarity score generated in block 610 could indicate, e.g., a 95% likelihood that the current photograph and the prior photograph are of the same person. In the illustrated embodiment, if the 95% similarity score is equal to or greater than the similarity threshold, the routine 600 positively identifies the user 101 as matching the user whose information is stored in the database. In block 620, the routine 600 determines whether the positively identified user 101 is allowed to use the kiosk 100, based on information about the user 101 stored in the database. For example, the database may indicate that the user 101 is a repeat customer who has conducted successful transactions at the kiosk 100. In that instance, the routine 600 approves the user 101 and allows the user 101 to proceed with the current transaction at the kiosk 100. As another example, the database may contain an indication that the user is on a do-not-buy list (e.g., the list described above with reference to FIG. 3C) as a result of having sold or tried to sell a stolen phone at the kiosk 100 on a prior occasion. In that instance, the routine 600 prohibits the user 101 from proceeding with the transaction at the kiosk 100. For example, the kiosk 100 can return any electronic device submitted by the user 101, and present a message on the display screen 104 stating that the kiosk 100 will not do business with the user 101. After block 620, the routine 600 ends.

In one aspect of the present technology, this automated approach to user verification enables a user's identity to be automatically verified without human intervention, such as without review by a remotely located human operator 334 of FIG. 3B. Accordingly, the present technology can reduce labor costs, avoid human error, and reduce verification delays that might occur with other verification systems. In another embodiment, the routine 600 can enhance kiosk security by requiring facial recognition of kiosk service personnel or administrators based on comparison to an authenticated image. For example, authorized personnel can periodically collect electronic devices from the kiosk 100 and stock the kiosk 100 with funds for purchasing electronic devices. Such personnel can gain access to the inside of the kiosk 100 using a key and/or a login password that could be stolen or copied. However, when authorized personnel must be recognized by the routine 600 before they can gain access, the kiosk 100 remains resistant to access by unauthorized individuals.

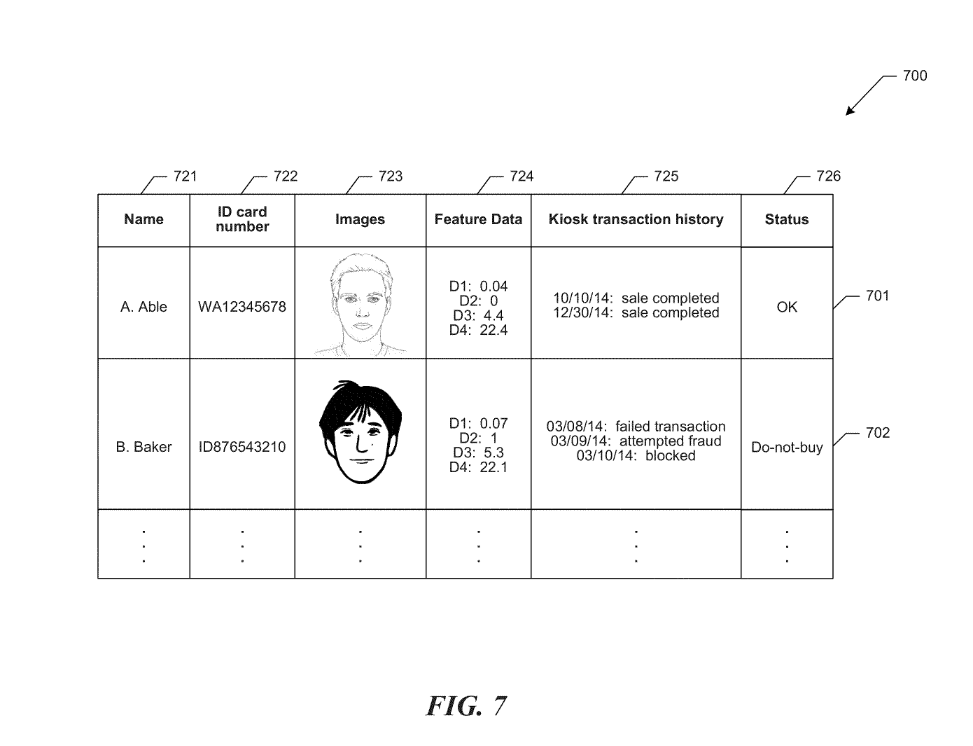

FIG. 7 is a table 700 of known user information configured in accordance with an embodiment of the present technology. The known users table 700 includes rows 701 and 702, each containing information about a user that has previously used one of the kiosks 100. Information in the table 700 can also be obtained from other sources, such as another type of kiosk (e.g., a movie rental kiosk), a law enforcement database, an app running on the user's mobile device and operably connected to the kiosk, etc. In the illustrated embodiment, each row in the table 700 is divided into a name column 721 containing the user's name; an ID number column 722 containing a unique identification number for the user (e.g., a driver's license number); an images column 723 containing one or more images of the user (e.g., facial images); a feature data column 724 containing information associated with one or more of the user images (e.g., features of each image, features of the most recent image, and/or a composite or aggregate of features of the user's images); a transaction history column 725 identifying past transactions conducted by the user at the kiosk 100; and a status column 726 indicating whether the user is, for example, approved to use the kiosk 100 or is on a do-not-buy list of blocked users.

In the illustrated embodiment, row 701 provides information about user A. Able, including, e.g., a Washington identification card number, a facial image, a set of feature data specific to the image, records of previous completed transactions at one or more of the kiosks 100, and an “OK” status indicator. Row 702 provides analogous information about user B. Baker, including, e.g., an Idaho identification card number, a facial image, a set of feature data specific to the image, records of attempted transactions that were blocked, and a “Do-not-buy” status indicator. The table thus depicts various information about recognized users, including both repeat approved users and blocked users.

Although FIG. 7 presents one example of a suitable information table, those skilled in the art will appreciate that the present technology can use tables having columns corresponding to different, fewer, and/or greater numbers of columns, as well as a larger number of rows. Columns that can be used include, for example, various types of user biographic data (e.g., details from the user's driver's license), fingerprint data, detailed information about when the user has been at kiosks and what items the user has sold (at a recycling kiosk 100), purchased (e.g., at a gift card kiosk) or rented (at a rental kiosk), whether the user has an account or has installed an associated mobile app on the user's electronic devices, etc. Although the contents and organization of the table 700 are designed to make them more comprehensible by a human reader, those skilled in the art will appreciate that actual data structures used by the present technology to store this information can differ from the table shown. For example, they can be organized in a different manner (e.g., in multiple different data structures); can contain more or less information than shown; can be compressed and/or encrypted; etc.

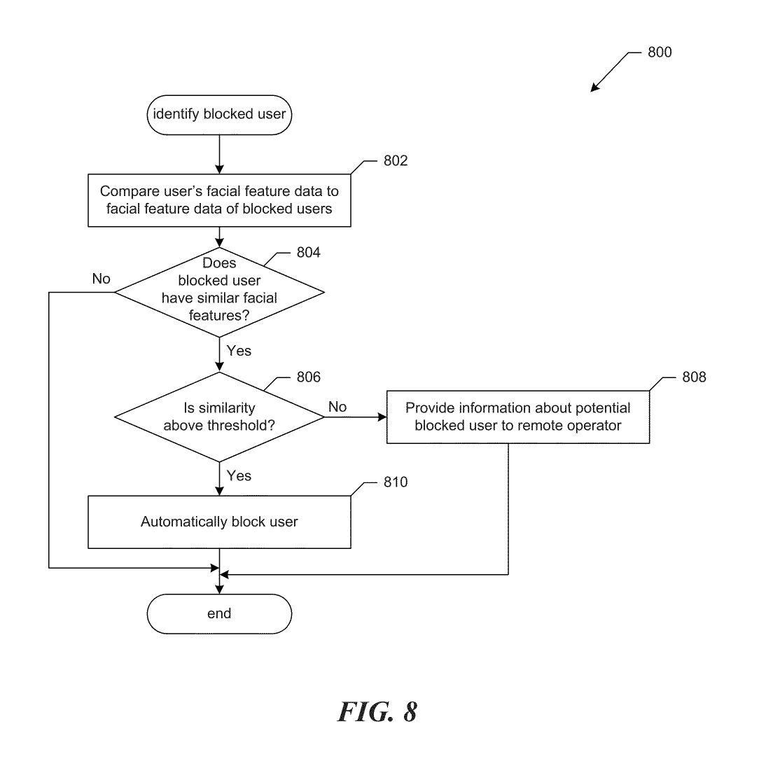

FIG. 8 is a flow diagram of a routine 800 for identifying a blocked user in accordance with an embodiment of the present technology. In various embodiments, the kiosk 100 and/or one or more remote servers operably connectable to the kiosk 100 can perform some or all of the routine 800. The routine 800 employs facial recognition to identify blocked users (e.g., individuals who have committed fraud or attempted to do so in the past and who have been blocked from using the kiosk 100 as a result) and to render the kiosk inoperable to those users. To do so, the routine 800 can maintain a facial image database of blocked people, and can use facial recognition to check each user at the kiosk against that database.

The routine 800 begins with the kiosk 100 having photographed the user and analyzed the photograph to generate feature data as described above with reference to FIG. 4. In block 802, the routine compares the user's feature data to the feature data of each person in the list of blocked users. In decision block 804, the routine 800 determines whether any of the blocked users have feature data similar to the user (e.g., similar facial features). If not, then the routine 800 ends. If, on the other hand, one or more blocked users have feature data resembling the user's feature data, then the routine 800 proceeds to decision block 806. In decision block 806, the routine 800 determines whether the similarity is above a threshold indicating a high confidence of a match between the user and the blocked user. For example, the routine 800 can determine a similarity score that represents the level of similarity between the feature data of the user and the feature data of the blocked user, and if that similarity score is above a preset threshold, then the match can be deemed high confidence. If there is a high confidence match between the user at the kiosk and a blocked user, then the routine 800 continues to block 810 and automatically blocks the user from using the kiosk. If the match between the kiosk user and a blocked person is not a high confidence match, then the routine 800 proceeds to block 808 and provides information about the potential blocked user to a human operator, such as the remote operator 334 of FIG. 3C. For example, the routine 800 can provide the images of the user at the kiosk and the blocked user and a similarity score and/or recommendation to the remote operator. The operator can then review the similarity score and/or recommendation and decide whether to prohibit the user from proceeding with the transaction at the kiosk 100 based on the user's similarity to the blocked user. After block 808 or 810, the routine 800 ends.

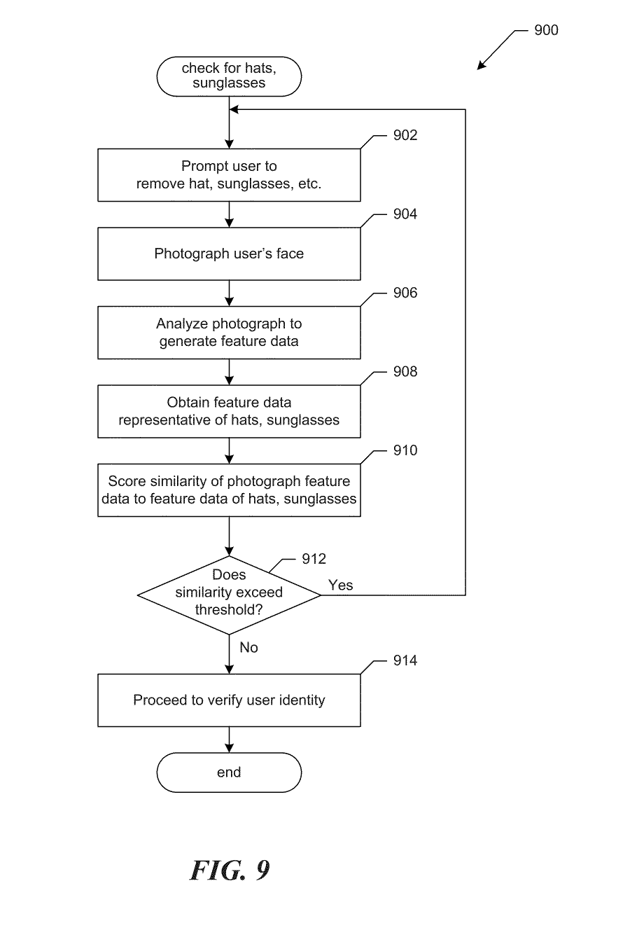

FIG. 9 is a flow diagram of a routine 900 to facilitate the removal of objects that the user may be wearing that can interfere with facial recognition, such as headwear (e.g., a hat or hood) or eyewear (e.g., sunglasses), prior to facial recognition in accordance with an embodiment of the present technology. In various embodiments, the kiosk 100 and/or one or more remote servers operably connectable to the kiosk 100 can perform some or all of the routine 900. User identification photos (on, e.g., a driver's license) typically require the user's face to be free of headwear, such as a hat, and eyewear, such as sunglasses. In some instances, however, a user may arrive at the kiosk 100 wearing sunglasses, a hood, or a hat. As a result, it can be difficult to match a photograph of the user's face to the user's ID photo, and if a sufficient match is not made, the kiosk 100 and/or a remote operator 334 may unnecessarily prevent the user from undertaking the desired transaction. The routine 900 of FIG. 9 enables the kiosk 100 to detect the presence of hats, sunglasses, and other such items and prompt the user to remove them before proceeding with facial comparison, thereby providing more informative images and resulting in fewer rejections of valid users.

In block 902, the routine 900 begins by prompting the user to remove any and/or sunglasses before taking the user's photograph. For example, the routine 900 can cause the kiosk 100 to display one or more display pages on the display screen 104 of FIG. 1 that instruct the user to remove such items in preparation for a photograph. In block 904, the routine 900 takes a photograph of the user's face. For example, the kiosk 100 can take a photograph of the user with the camera 116a to compare the user with his or her ID card picture. In block 906, the routine 900 analyzes the photograph of the user (e.g., identifying facial features) to generate feature data relating to the photograph of the user, as described above with reference to FIG. 4.

In block 908, the routine 900 obtains feature data representative of the presence of a hat, a hood, sunglasses, a headband, a visor, a mask, face paint, stickers or temporary tattoos, Google® Glass™, and/or other items that may obstruct a clear view of the user's face (e.g., a hand partially obstructing the lens of the camera 116a). The routine 900 can obtain such feature data from a database that contains previously generated feature data associated with such items. For example, the routine 900 can identify feature data that are indicative of such items being worn by a user by processing a set of images that include various types of hats, hoods, sunglasses, etc. (a “training set”). The routine 900 can utilize machine learning (e.g., a support vector machine (SVM) model) and/or various statistical techniques to identify the most salient feature data that indicate the presence of headwear or eyewear.

In block 910, the routine 900 compares the feature data of block 906 to the feature data of block 908 and assesses the level of similarity of the feature data of the user's photograph to the feature data consistent with the wearing of potentially obstructing items, such as hats, hoods, and sunglasses. In some embodiments, the routine 900 can determine a degree of correlation between values in the feature data of block 906 and values in the feature data of block 908. If, for example, the feature data in the photograph is also present in images representing, e.g., sunglasses, then the routine 900 can determine that there is an increased likelihood that the user is wearing sunglasses. The relationship between one or more levels of similarity or correlations and the likelihood that the user is wearing an item need not be linear. For example, sunglasses come in many different shapes and styles, and the routine 900 can aggregate multiple comparisons to generate an overall similarity score. For example, the routine 900 can assign a probability score, such as a value between zero and one, that represents the likelihood that the user is wearing sunglasses. The routine 900 can assign different probabilities to different items that the user may be wearing, and/or an overall probability that the user is wearing any item that might obstruct the user's face or otherwise interfere with facial recognition.

In decision block 912, the routine 900 determines whether the similarity score exceeds a preset threshold. If so, then the routine 900 returns to block 902. For example, if the threshold is set at 0.8 (80%), and if the routine 900 determines that the likelihood that the user is wearing a hat is 0.82 (82%), then the routine 900 returns to block 902 and causes the kiosk 100 to display a display page to prompt the user to remove the hat or other item. On the other hand, if the similarity score does not exceed the preset threshold, then the routine 900 proceeds to block 914 to verify the user's identity, as described in detail above with reference to FIG. 4 or FIG. 6. Additionally, in some embodiments the routine 900 can notify the remote operator 334 that an object such as a hat or sunglasses may be present, if, for example, the similarity score from block 910 is not high enough to cause automatic rejection of the user's photograph(s) but not low enough to be confident that such items are absent. After block 914, the routine 900 ends. In the depicted example, the present technology improves the efficiency and accuracy of automated and human-assisted verification systems by detecting that a user is wearing headwear or eyewear and prompting the user to remove such items before having their picture taken.

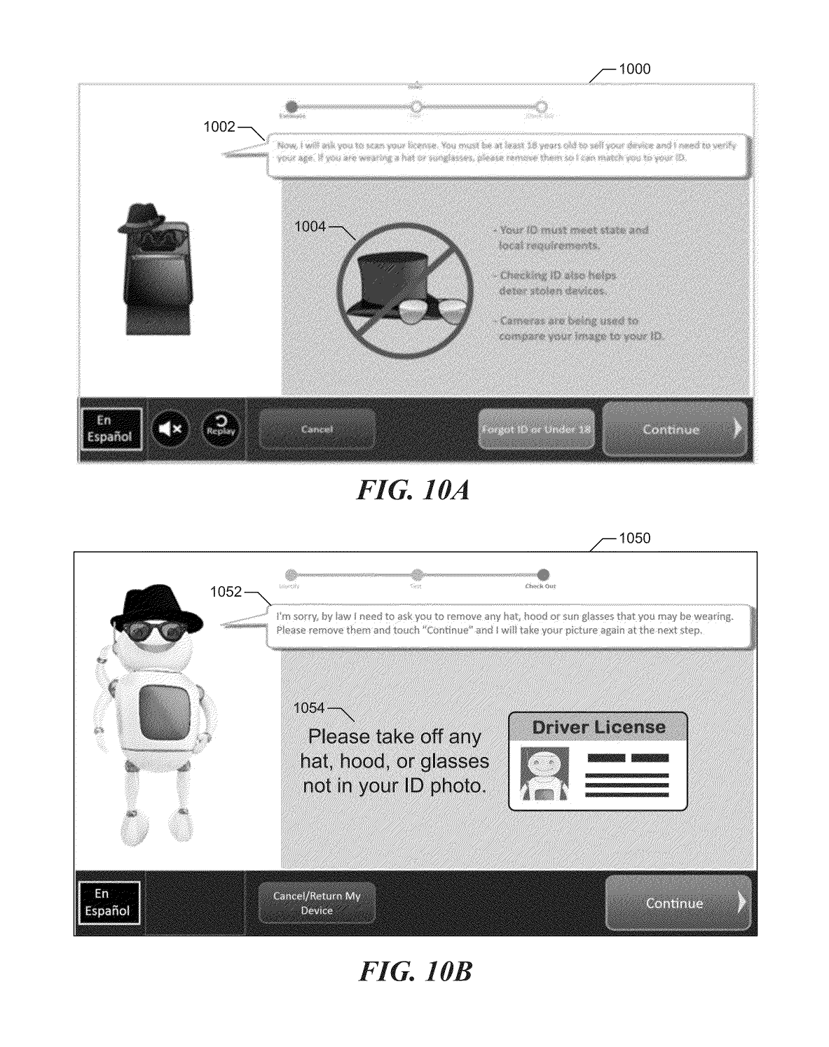

FIGS. 10A and 10B are display pages 1000 and 1050, respectively, illustrating screen displays of graphical user interfaces associated with prompting a user to remove headwear and/or eyewear (e.g., a hat or sunglasses) in accordance with embodiments of the present technology. In some embodiments, the kiosk 100 can display the illustrated information on the display screen 104 of FIG. 1. Referring first to FIG. 10A, the display page 1000 notifies the user that that the kiosk 100 will be taking a photograph of the user in conjunction with scanning the user's license or ID. In the illustrated example, the display page 1000 includes notification or instruction text 1002, which states, “if you are wearing a hat or sunglasses, please remove them.” The display page 1000 also includes a graphic icon 1004, visually indicating that hats and sunglasses are not allowed.

Turning next to FIG. 10B, the display page 1050 can be presented to a user if the user fails to remove prohibited headwear or eyewear (e.g., a hat or sunglasses). For example, when the present technology detects such items as described above with reference to FIG. 9, then the kiosk 100 can display the display page 1050. The display page 1050 includes text 1052 again asking the user “to remove any hat, hood or sun glasses that you may be wearing” so that the kiosk can “take your picture again.” The display page 1050 also includes a larger message 1054 to the user that plainly states, “Please take off any hat, hood, or glasses not in your ID photo.” In some embodiments, the kiosk 100 can display various versions of FIG. 10B tailored to specific rejections (e.g., specific to a hat, to sunglasses, or to a user hiding his or her face or blocking a camera). For example, in some embodiments, the kiosk 100 can display a photograph of the user with the offending item highlighted, thereby enabling the user to understand and correct the issue more easily. For example, the user may not be aware that he or she is wearing a hat or sunglasses.

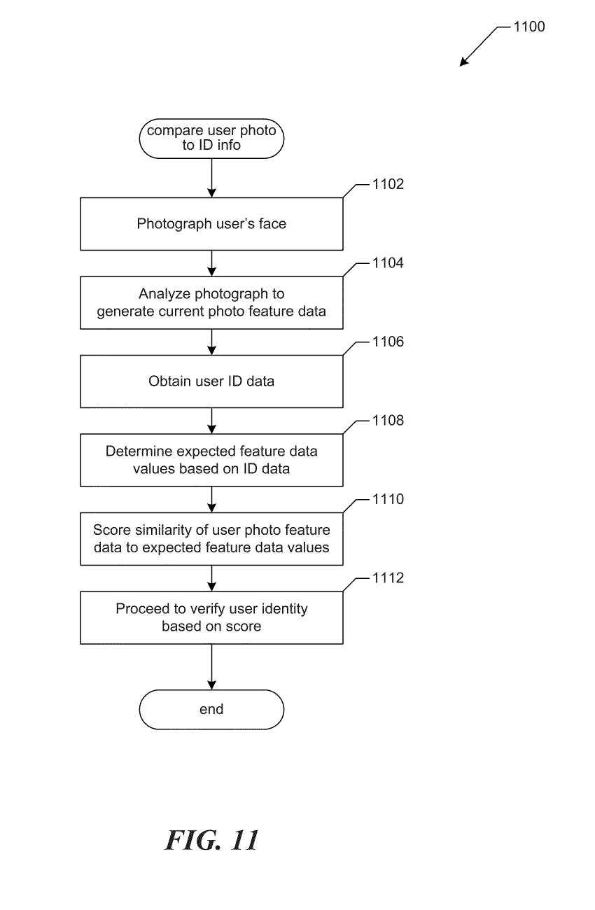

FIG. 11 is a flow diagram of a routine 1100 for comparing a face of a user to identification information in accordance with an embodiment of the present technology. In various embodiments, the kiosk 100 and/or one or more remote servers operably connectable to the kiosk 100 can perform some or all of the routine 1100. The routine 1100 enables a verification system to use information from the user's ID card (e.g., the driver's license 303 of FIG. 3A) to evaluate the likelihood that the user is the person described on the ID card. For example, a driver's license typically includes information about physical features such as eye color and height that can be verified in a photo of the user. A user whose height is listed as 5′ 7″ on the driver's license 303 is highly unlikely to appear to be 4′ 11″ (i.e., eight inches shorter) at the kiosk 100. The routine 1100 can produce a score or rating indicating a probability that the user photographed at the kiosk is the person described on the ID card.

In block 1102, the routine 1100 begins by taking a photograph or photographs of the user, as described above. In block 1104, the routine 1100 analyzes the photograph or photographs to generate feature data corresponding to the current photograph, as described above. In block 1106, the routine 1100 obtains the user's ID data by, for example, scanning the driver's license 303 via the ID scanner 112 of the kiosk 100. For example, the routine 1100 can scan or photograph the driver's license 303 and perform OCR to recognize words in the image as text, as described above with reference to the ID recognition component of FIG. 3B. The routine 1100 can also obtain information about the owner of the ID card by decoding data from, e.g., a barcode, a magnetic stripe, an RFID chip, etc. carried by the ID card.

In block 1108, the routine 1100 determines expected feature data values based on the ID data obtained in block 1106. Such data can be retrieved from a data structure that associates various types of user identification data with typical photographic feature data values. For example, ID data such as height can be associated with feature data values such as the location of the top of the user's head in a photograph taken at the kiosk. As another example, ID data describing eye color (e.g., “blue” or “BLU”) can be associated with feature data values such as the luminance of pixels in the photograph centered around the user's pupils. In some embodiments, the routine 1100 can collect the ID data and feature data values of multiple users, aggregate the data, and utilize statistical analysis and/or machine learning techniques to identify correlations in the collected data and determine which may be significant. For example, small variations in height may not be significant, as people may exaggerate when reporting their height on an ID card (e.g., adding an inch), and many women wear high-heeled shoes that can increase their height by a few inches. On the other hand, large differences in height can be expected to be rare—especially large decreases in height. Accordingly, the data structure can indicate, for example, a statistically typical range and variance of expected values that enables the routine 1100 to identify outlier values. Such outlier values can be indicative of a person whose photograph does not match the submitted ID card information.

In block 1110, the routine 1100 scores the similarity of the user's feature data to the expected feature data based on the user's ID card information. For example, the routine 1100 can generate a statistical likelihood that the observed feature data values of the current photograph are consistent with the expected values associated with the information from the user ID card. Such a similarity score can also be generated as described above with reference to the similarity score 322 of FIG. 3A. In block 1112, the routine 1100 proceeds to verify the user's identity based on the similarity score generated in block 1110, such as by providing the similarity score to a remote operator as described above with reference to block 414 of FIG. 4. After block 1112, the routine 1100 ends.

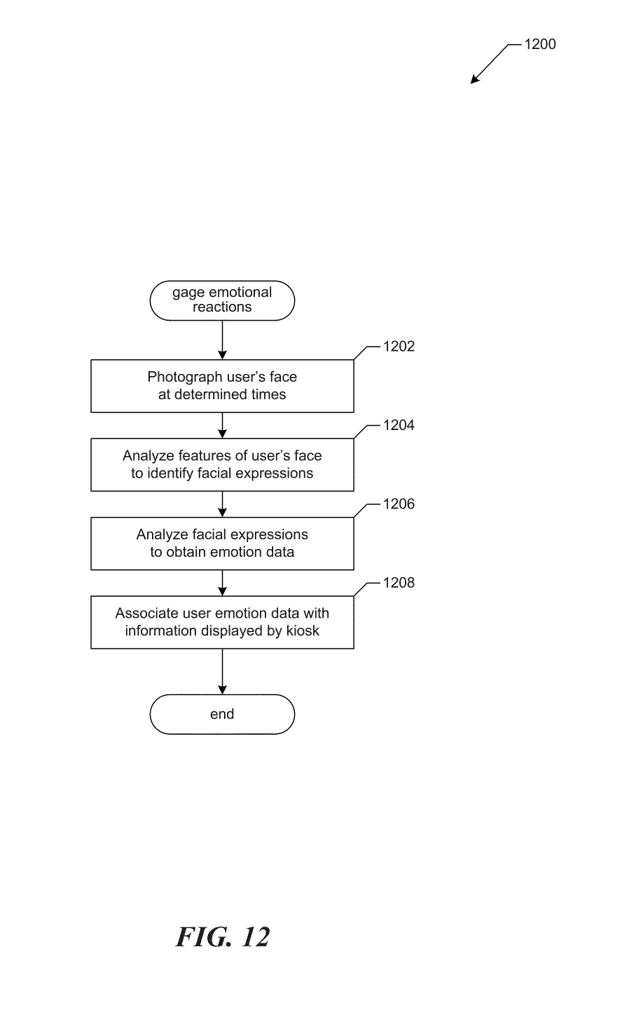

FIG. 12 is a flow diagram of a routine 1200 for gauging emotional reactions of a kiosk user in accordance with an embodiment of the present technology. In various embodiments, the kiosk 100 and/or one or more remote servers operably connectable to the kiosk 100 can perform some or all of the routine 1200. In this embodiment, the routine 1200 can use facial recognition techniques to recognize facial expressions that can be associated with emotions, and thereby evaluate the reactions of customers during kiosk transactions. Positive and negative emotions can reveal, for example, how customers feel about a particular screen or about pricing information. The routine 1200 can assess customer confusion, frustration, and/or happiness to evaluate the usability of a particular screen or instruction, the design of a kiosk transaction process, the attractiveness of marketing materials, an offer price for the user's electronic device, etc.

In block 1202, the routine 1200 takes photographs of the user's face at determined times. For example, the routine 1200 can photograph the user at the beginning of the transaction (e.g., when the user arrives at the kiosk, and/or when the user is asked to pose for an identification photo), at key points during the flow of the transaction such as decision points and/or when a price is presented, and/or periodically or at regular intervals during a kiosk transaction. In some embodiments, the routine 1200 can capture video footage of the user during the course of a transaction.

In block 1204, the routine 1200 analyzes features of one or more photographs of the user's face to identify facial expressions at different times. For example, rather than comparing feature data to verify the identity of the user, the routine 1200 can analyze feature data to identify features such as a smile, a frown, a furrowed brow, etc. In some embodiments, the routine 1200 can compare the features in the user's expression to examples of, for example, happy, sad, angry, confused, and/or concerned faces.

In block 1206, the routine 1200 analyzes the facial expressions of the user to obtain emotional response data. In some embodiments, the routine 1200 categorizes emotions on a simple positive-negative scale, such as a two-value scale of zero for negative emotions and one for positive emotions, or a three-value scale of negative one for negative emotions, zero for neutral emotions, and one for positive emotions. In some embodiments, the routine 1200 rates emotions on a scale of continuous values over a range (which can include more than one dimension) rather than categorizing them into a set of discrete values. In some embodiments, the routine 1200 records changes in the user's emotions from a baseline expression at the beginning of the user's transaction or over the course of the user's transaction.

In block 1208, the routine 1200 associates the user emotion data with the information displayed by the kiosk when the emotion was recorded. For example, the routine 1200 can identify and collect multiple users' emotional response data collected at the time that the kiosk 100 presented an offer price for each user's electronic device. The routine 1200 can thus accumulate data showing how individual users and users in the aggregate respond to various information presented by the kiosk 100. The kiosk operator can use this information to develop kiosk user interface elements, marketing strategies, pricing policies, etc. After block 1208, the routine 1200 ends.

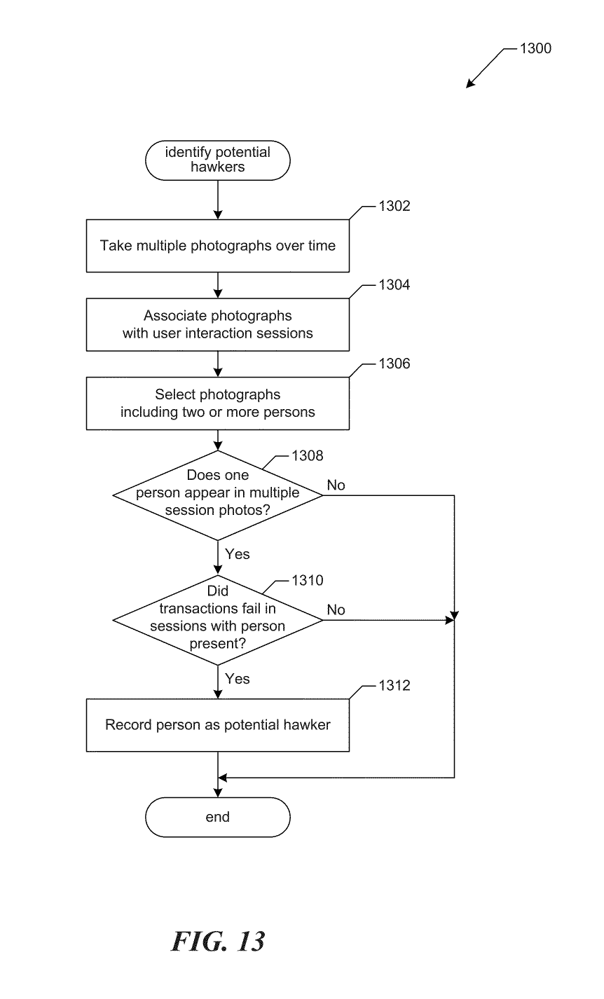

FIG. 13 is a flow diagram of a routine 1300 to identify potential “hawkers” in accordance with an embodiment of the present technology. In various embodiments, the kiosk 100 and/or one or more remote servers operably connectable to the kiosk 100 can perform some or all of the routine 1300. In some instances, people may engage in “hawking” at a kiosk. This can involve a person (the hawker) standing near the kiosk 100 and waiting for a customer to approach the kiosk to sell a used electronic device, such as a smartphone, at the kiosk 100. After the kiosk 100 evaluates the electronic device (e.g., the mobile phone 250) and makes an offer to the customer, the hawker approaches the customer and tries to persuade the customer to sell the electronic device to them, perhaps by offering the seller more for the electronic device than the kiosk did. The hawkers may attempt to purchase only premium devices that offer the best return in the resale market. In most cases, however, hawking violates the local rules and/or ordinances in places such as shopping malls where the kiosk 100 is located. The routine 1300 uses facial recognition hardware and/or software to identify a person standing near the kiosk 100 who may be hawking.

In block 1302, the routine 1300 takes a series of photographs over time. For example, the kiosk cameras 116 of FIG. 1 can take photographs and/or video of the area surrounding the kiosk 100 at the start of a transaction, at regular intervals, and/or when the cameras 116 and/or a motion sensor (not shown) detect a person near the kiosk 100. In block 1304, the routine 1300 associates one or more photographs with a user transaction session. In some embodiments, for example, the routine 1300 associates photographs between transaction sessions with the previous session or with the previous uncompleted session.

In block 1306, the routine 1300 selects photographs that include two or more people. For example, using facial recognition techniques such as those described in detail above, the routine 1300 can identify image features that correspond to a person standing in the vicinity of the kiosk 100 (by, e.g., generating feature data that is characteristic of a pedestrian within a certain distance of the kiosk 100). In some embodiments, the routine 1300 can track a person between photographs or video frames, and therefore distinguish between people walking past the kiosk 100 and people loitering near the kiosk 100.

In decision block 1308, the routine 1300 determines whether a person appears in multiple photographs, such as photographs associated with two or more user transaction sessions. If no person was present for more than one transaction, the routine 1300 can conclude that no one is loitering near the kiosk 100 for hawking purposes, and the routine 1300 ends. On the other hand, if a person appears across two or more user transaction sessions, then that person may be a hawker and the routine 1300 proceeds to decision block 1310.

In decision block 1310, the routine 1300 determines whether one or more transactions failed when the potential hawker was present. For example, the routine 1300 can record instances in which the kiosk 100 offered to purchase an electronic device from the user but the user rejected the offer. If no transactions failed, then the routine 1300 ends. If, however, transactions did fail in the presence of a potential hawker, then in block 1312 the routine 1300 records the images of the potential hawker. In some embodiments, the routine 1300 can capture images of the potential hawker and electronically notify authorities (via, e.g., an electronic message to mall management) to have the person investigated and, if hawking, removed. In some embodiments, the routine 1300 also adds the suspected hawker to a list of blocked users. After block 1312, the routine 1300 ends.

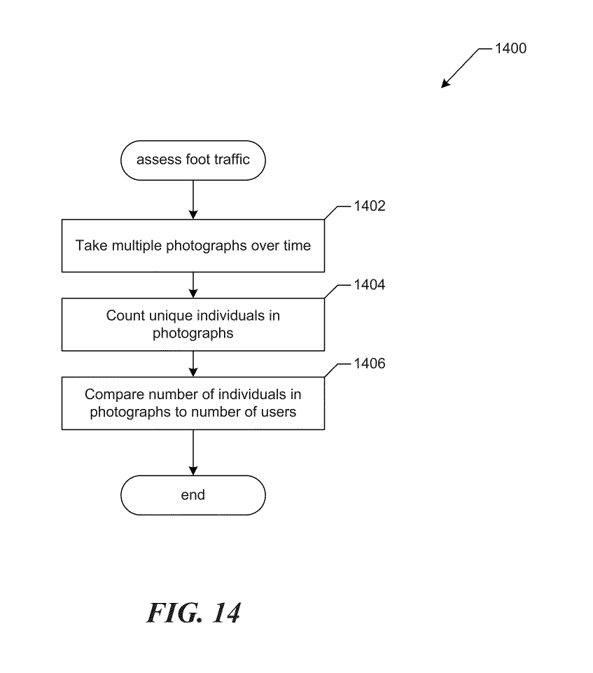

FIG. 14 is a flow diagram of a routine 1400 for assessing kiosk traffic in accordance with an embodiment of the present technology. In various embodiments, the kiosk 100 and/or one or more remote servers operably connectable to the kiosk 100 can perform some or all of the routine 1400. The routine 1400 enables the kiosk 100 to use facial recognition techniques to collect pedestrian data and perform foot traffic analysis. By tracking the number of people who walk past the kiosk 100 and/or the number of people who stop at the kiosk but do not interact with it in a given period of time, the routine 1400 can generate marketing data for assessing and improving kiosk placement and attractiveness.

In block 1402, the routine 1400 takes a series of photographs over time. For example, the kiosk cameras 116 of FIG. 1 can take photographs and/or video of the area surrounding the kiosk 100 continuously, at regular intervals, during a transaction, at certain times of day (e.g., at noon, 3 PM, and 6 PM daily) and/or when the cameras 116 and/or a motion sensor (not shown) detect a person passing by the kiosk 100. In block 1404, the routine 1400 counts the number of unique people in the photographs and/or video. For example, the routine 1400 can identify image features that correspond to an individual person in the vicinity of the kiosk 100, such as a user walking past the kiosk 100, as described above with reference to FIG. 13. In some embodiments, the routine 1400 distinguishes between pedestrians at or further than a predetermined distance from the kiosk 100 and those who pass at or within a predetermined distance of the kiosk 100. In block 1406, the routine 1400 compares the number of people who were counted in the photographs and/or video to the number of people who used the kiosk 100 and/or to the number of people who complete a transaction at the kiosk 100. By comparing the ratios of pedestrians to users and/or successful transactions at various kiosks, the routine 1400 can evaluate the quality of the location and/or the quality of placement of the kiosk 100, including how traffic and the popularity of the kiosk 100 vary over time (during the course of a day, over the course of a year, etc.).

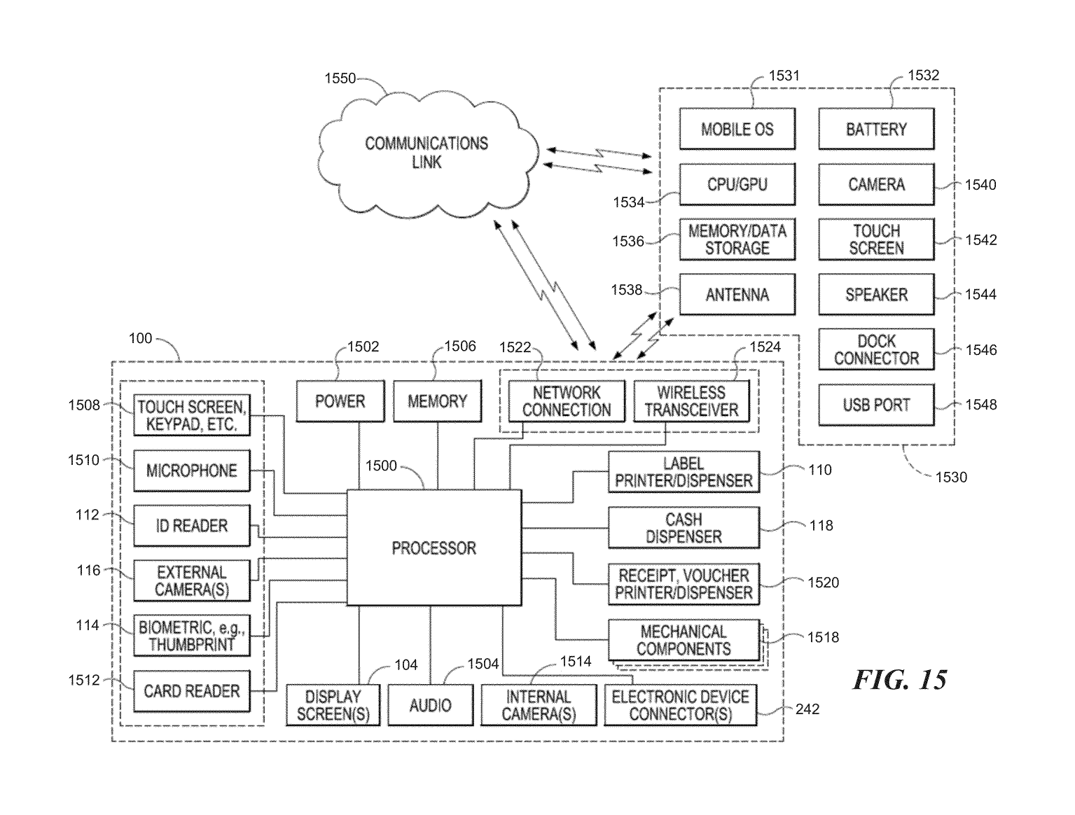

FIG. 15 provides a schematic representation of an architecture of the kiosk 100 in accordance with an embodiment of the present technology. In the illustrated embodiment, the kiosk 100 includes a suitable processor or central processing unit (CPU) 1500 that controls operation of the kiosk 100 in accordance with computer-readable instructions stored on system memory 1506. The CPU 1500 may be any logic processing unit, such as one or more CPUs, digital signal processors (DSPs), application-specific integrated circuits (ASICs), etc. The CPU 1500 may be a single processing unit or multiple processing units in an electronic device or distributed across multiple devices. The CPU 1500 is connected to the memory 1506 and may be coupled to other hardware devices, for example, with the use of a bus (e.g., a PCI Express or Serial ATA bus). The CPU 1500 can include, by way of example, a standard personal computer (PC) (e.g., a DELL® OptiPlex® 7010 PC) or other type of embedded computer running any suitable operating system, such as Windows®, Linux, Android™, iOS®, or an embedded real-time operating system. In some embodiments, the CPU 1500 can be a small form factor PC with integrated hard disk drive (HDD) or solid-state drive (SSD) and USB or other ports to communicate with the other components of the kiosk 100. In other embodiments, the CPU 1500 can include a microprocessor with a standalone motherboard that interfaces with a separate HDD. The memory 1506 can include read-only memory (ROM) and random access memory (RAM) or other storage devices, such as disk drives or SSDs, that store the executable applications, test software, databases and other software required to, for example, control kiosk components, process electronic device information and data (to, e.g., evaluate device make, model, condition, pricing, etc.), communicate and exchange data and information with remote computers and other devices, etc.

The CPU 1500 can provide information and instructions to kiosk users via the display screen 104 and/or an audio system (e.g., a speaker) 1504. The CPU 1500 can also receive user inputs via, e.g., a touch screen 1508 associated with the display screen 104, a keypad with physical keys, and/or a microphone 1510. Additionally, the CPU 1500 can receive personal identification and/or biometric information associated with users via the ID scanner 112, one or more of the external cameras 116, and/or the biometric reader 114. In some embodiments, the CPU 1500 can also receive information (such as user identification and/or account information) via a card reader 1512 (e.g., a debit, credit, or loyalty card reader having, e.g., a suitable magnetic stripe reader, optical reader, etc.). The CPU 1500 can also control operation of the label dispenser 110 and systems for providing remuneration to users, such as the cash dispenser 118 and/or a receipt or voucher printer and an associated dispenser 1520.

As noted above, the kiosk 100 additionally includes a number of electronic, optical and electromechanical devices for electrically, visually and/or physically analyzing electronic devices placed therein for recycling. Such systems can include one more internal cameras 1514 for visually inspecting electronic devices for, e.g., determining external dimensions and condition, and one or more of the electrical connectors 242 (e.g., USB connectors) for, e.g., powering up electronic devices and performing electronic analyses. As noted above, the cameras 1514 can be operably coupled to the upper and lower chambers 230 and 232, and the connectors 242 can be movably and interchangeably carried by the carrousel 240 of FIGS. 2A-2D. The kiosk 100 further includes a plurality of mechanical components that are electronically actuated for carrying out the various functions of the kiosk 100 during operation. The mechanical components 1518 can include, for example, the inspection area access door 106 and one or more of the movable components (e.g. the inspection plate 244, the upper and lower chambers 230 and 232, etc.) operably disposed within the inspection area 108 of FIG. 1. The kiosk 100 further includes power 1502, which can include battery power and/or facility power for operation of the various electrical components associated with kiosk operation.

In the illustrated embodiment, the kiosk 100 further includes a network connection 1522 (e.g., a wired connection, such as an Ethernet port, cable modem, FireWire cable, Lightning connector, USB port, etc.) suitable for communication with, e.g., all manner of processing devices (including remote processing devices) via a communication link 1550, and a wireless transceiver 1524 (e.g., including a Wi-Fi access point; Bluetooth transceiver; near-field communication (NFC) device; wireless modem or cellular radio utilizing GSM, CDMA, 3G and/or 4G technologies; etc.) suitable for communication with, e.g., all manner of processing devices (including remote processing devices) via the communication link 1550 and/or directly via, e.g., a wireless peer-to-peer connection. For example, the wireless transceiver 1524 can facilitate wireless communication with electronic devices, such as an electronic device 1530 either in the proximity of the kiosk 100 or remote therefrom. In the illustrated embodiment, the electronic device 1530 is depicted as a handheld device, e.g., a mobile phone. In other embodiments, however, the electronic device 1530 can be other types of electronic devices including, for example, other handheld devices; PDAs; MP3 players; tablet, notebook and laptop computers; e-readers; cameras; desktop computers; TVs; DVRs; game consoles; Google® Glass™; smartwatches; etc. By way of example only, in the illustrated embodiment the electronic device 1530 can include one or more features, applications and/or other elements commonly found in smartphones and other known mobile devices. For example, the electronic device 1530 can include a CPU and/or a graphics processing unit (GPU) 1534 for executing computer readable instructions stored on memory 1536. In addition, the electronic device 1530 can include an internal power source or battery 1532, a dock connector 1546, a USB port 1548, a camera 1540, and/or well-known input devices, including, for example, a touch screen 1542, a keypad, etc. In many embodiments, the electronic device 1530 can also include a speaker 1544 for two-way communication and audio playback. In addition to the foregoing features, the electronic device 1530 can include an operating system (OS) 1531 and/or a device wireless transceiver that may include one or more antennas 1538 for wirelessly communicating with, for example, other electronic devices, websites, and the kiosk 100. Such communication can be performed via, e.g., the communication link 1550 (which can include the Internet, a public or private intranet, a local or extended Wi-Fi network, cell towers, the plain old telephone system (POTS), etc.), direct wireless communication, etc.

Unless described otherwise, the construction and operation of the various components shown in FIG. 15 are of conventional design. As a result, such components need not be described in further detail herein, as they will be readily understood by those skilled in the relevant art. In other embodiments, the kiosk 100 and/or the electronic device 1530 can include other features that may be different from those described above. In still further embodiments, the kiosk 100 and/or the electronic device 1530 can include more or fewer features similar to those described above.

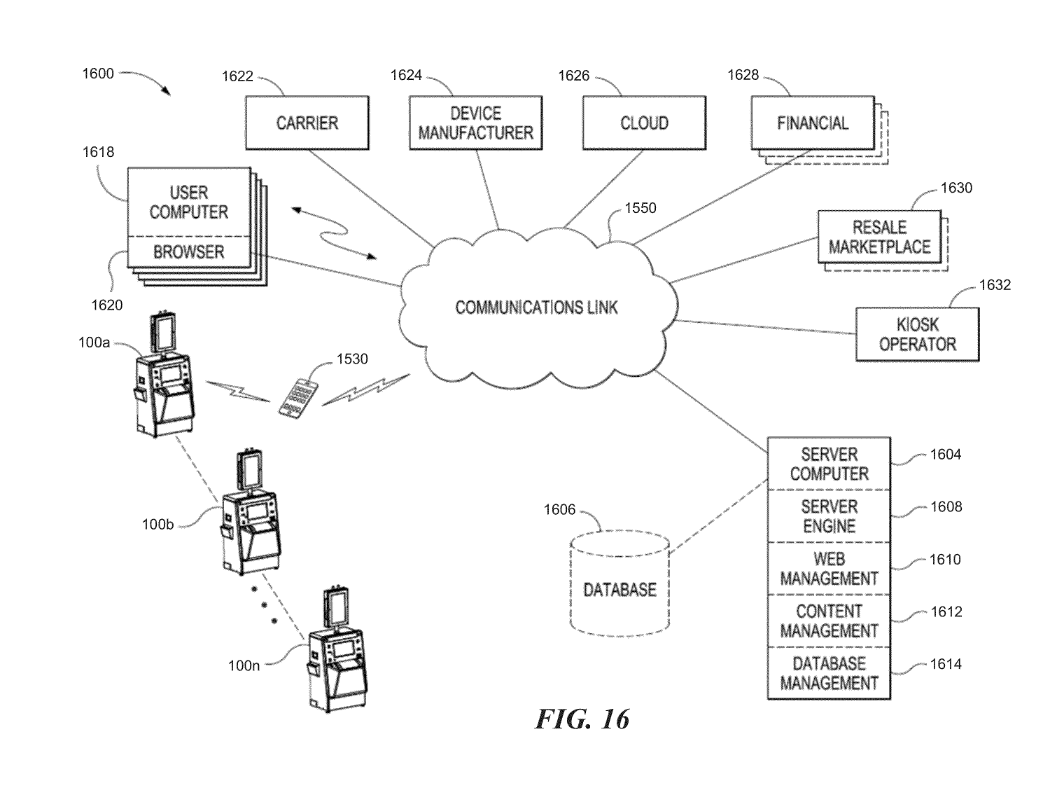

FIG. 16 is a schematic diagram of a suitable network environment for implementing various aspects of an electronic device recycling system 1600 configured in accordance with an embodiment of the present technology. In the illustrated embodiment, a plurality of the kiosks 100 (identified individually as kiosks 100a-100n) can exchange information with one or more remote computers (e.g., one or more server computers 1604) via the communication link 1550. Although the communication link 1550 can include a publically available network (e.g., the Internet with a web interface), a private communication link, such as an intranet or other network can also be used. Moreover, in various embodiments the individual kiosk 100 can be connected to a host computer (not shown) that facilitates the exchange of information between the kiosks 100 and remote computers, other kiosks, mobile devices, etc.

The server computer 1604 can perform many or all of the functions for receiving, routing and storing of electronic messages, such as webpages, audio signals and electronic images necessary to implement the various electronic transactions described herein. For example, the server computer 1604 can retrieve and exchange web pages and other content with an associated database or databases 1606. In some embodiments, the database 1606 can include information related to mobile phones and/or other consumer electronic devices. Such information can include, for example, make, model, serial number, International Mobile Equipment Identity (IMEI) number, carrier plan information, pricing information, owner information, etc. In various embodiments the server computer 1604 can also include a server engine 1608, a web page management component 1610, a content management component 1612, and a database management component 1614. The server engine 1608 can perform the basic processing and operating system level tasks associated with the various technologies described herein. The webpage management component 1610 can handle creation and/or display and/or routing of web or other display pages. The content management component 1612 can handle many of the functions associated with the routines described herein. The database management component 1614 can perform various storage, retrieval and query tasks associated with the database 1606, and can store various information and data such as animation, graphics, visual and audio signals, etc.

In the illustrated embodiment, the kiosks 100 can also be operably connected to a plurality of other remote devices and systems via the communication link 1550. For example, the kiosks 100 can be operably connected to a plurality of user devices 1618 (e.g., personal computers, laptops, handheld devices, etc.) having associated browsers 1620. Similarly, as described above the kiosks 100 can each include wireless communication facilities for exchanging digital information with wireless-enabled electronic devices, such as the electronic device 1530. The kiosks 100 and/or the server computer 1604 are also operably connectable to a series of remote computers for obtaining data and/or exchanging information with necessary service providers, financial institutions, device manufactures, authorities, government agencies, etc. For example, the kiosks 100 and the server computer 1604 can be operably connected to one or more cell carriers 1622, one or more device manufacturers 1624 (e.g., mobile phone manufacturers), one or more electronic payment or financial institutions 1628, one or more databases (e.g., the GSMA Database, etc.), and one or more computers and/or other remotely located or shared resources associated with cloud computing 1626. The financial institutions 1628 can include all manner of entity associated with conducting financial transactions, including banks, credit/debit card facilities, online commerce facilities, online payment systems, virtual cash systems, money transfer systems, etc.

In addition to the foregoing, the kiosks 100 and the server computer 1604 can also be operably connected to a resale marketplace 1630 and a kiosk operator 1632. The resale marketplace 1630 represents a system of remote computers and/or services providers associated with the reselling of consumer electronic devices through both electronic and brick and mortar channels. Such entities and facilities can be associated with, for example, online auctions for reselling used electronic devices as well as for establishing market prices for such devices. The kiosk operator 1632 can be a central computer or system of computers for controlling all manner of operation of the network of kiosks 100. Such operations can include, for example, remote monitoring and facilitating of kiosk maintenance (e.g., remote testing of kiosk functionality, downloading operational software and updates, etc.), servicing (e.g., periodic replenishing of cash and other consumables), performance, etc. In addition, the kiosk operator 1632 can further include one or more display screens operably connected to cameras located at each of the kiosks 100 (e.g., one or more of the cameras 116 described above with reference to FIG. 1). This remote viewing capability enables operator personnel to verify user identification and/or make other visual observations at the kiosks 100 in real-time during transactions, as described above with reference to FIG. 1.

The foregoing description of the electronic device recycling system 1600 illustrates but one possible network system suitable for implementing the various technologies described herein. Accordingly, those of ordinary skill in the art with appreciate that other systems consistent with the present technology can omit one or more of the facilities described in reference to FIG. 16, or can include one or more additional facilities not described in detail in FIG. 16.

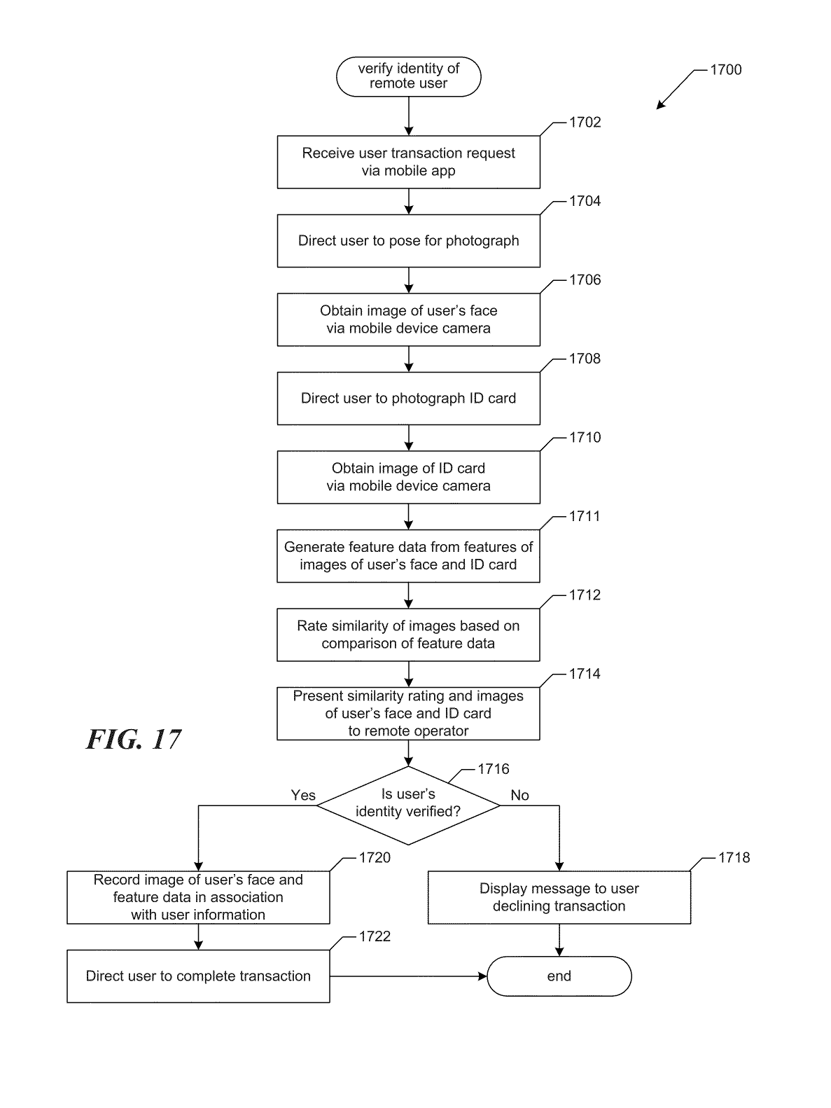

FIG. 17 is a flow diagram of a routine 1700 for verifying the identity of an electronic device user in accordance with another embodiment of the present technology. In some embodiments, for example, the routine 1700 enables the user to use his or her own mobile device to photograph himself or herself and an ID card. After the routine 1700 performs feature recognition and feature comparison of the two images from the mobile device in a manner such as described in detail above, both of the images and a similarity score are transmitted to a remote operator. The remote operator and/or an automated identity verification system can then verify that the user is the person shown on the ID card, using methods and systems such as those described in detail above. As a result, the user can later proceed with a transaction at a device recycling kiosk based on the previous verification of his or her identity, and/or the user can proceed to conduct a transaction remotely, such as by mail.

In various embodiments, a mobile electronic device (e.g., the electronic device 1530 of FIG. 15) operably connectable to a consumer-operated kiosk (e.g., the kiosk 100 of FIG. 1), the consumer-operated kiosk, and/or one or more other processing devices can perform some or all of the routine 1700. For example, the electronic device 1530 can run an app stored in the memory 1536 that includes computer-executable instructions to be executed by the CPU/GPU 1534. The routine 1700 can cause the electronic device 1530 to obtain one or more images via the camera 1540; transmit the images to a remote server that then generates sets of feature data based on the images and that generates a similarity score by comparing the sets of feature data; and then cause the images, the feature data, and/or the similarity score to be transmitted to a verification facility for review, such as review by a remote operator (e.g., the remote operator 334 of FIG. 3A). The routine 1700 can then provide guidance to the user based on whether the user's identity was successfully verified.

The routine 1700 begins in block 1702 when the app receives a transaction request from the user. For example, the user may desire to sell a smartphone or other electronic device (a “target device”), such as the device running the app (e.g., the electronic device 1530). The user can take steps to determine its value, such as by requesting an offer price for the target device via the app. The app can present an offer price for the target device, and the user may then agree to sell or recycle the target electronic device for the offer price. The app can then offer to verify the user's identity instead of directing the user to go to a kiosk to complete the transaction.

In block 1704, the routine 1700 directs the user to pose for a self-photograph. For example, the routine 1700 can display instructions on the touch screen 1542 and/or play an audio message via the speaker 1544 of the electronic device 1530. The instructions can direct the user to hold the electronic device camera directly in front of his or her face to obtain a straight-on view similar to the perspective of a driver's license photo. In some embodiments, the routine 1700 can detect the ambient light level via the electronic device camera and if there is not enough light to obtain a useful image of the user, can direct the user to turn on lights, enable a camera flash, etc. In some embodiments, the app assists the user to pose and capture an image of himself or herself. For example, on the screen of an electronic device having a front-facing camera, the routine 1700 can present an outline in which the user can align the image and then take a self-photograph. As another example, to obtain an image of the user that is properly sized and aligned (such as to match images that a kiosk camera would capture), the routine 1700 can control the shutter and photograph the user only after detecting that the user's face is properly positioned in the camera's view. In block 1706, the routine 1700 obtains the image of the user via the electronic device camera. In some embodiments, the routine 1700 obtains the image of the user and then selects a portion of the image for feature analysis, such as by cropping and/or rotating the image.

In block 1708, the routine 1700 directs the user to photograph his or her ID card, such as the driver's license 303 of FIG. 3A, via the electronic device camera in a similar manner to the directions presented in block 1704. In block 1710, the routine 1700 obtains the image of the user's ID card. After obtaining images of both the user's face and the user's ID card, the electronic device can perform image feature recognition and comparison in a manner similar to that described in detail above, and/or transmit the images to a server for such feature recognition and comparison. Thus, in block 1711, the routine 1700 generates sets of feature data representing features of each image, as described in detail above with reference to FIG. 4. In block 1712, the routine 1700 rates the level of similarity of the image of the user's face and the image of the ID card by comparing the feature data and producing a similarity score, as described in detail above with reference to FIG. 4. In block 1714, the routine 1700 proceeds to verify the user's identity based on the similarity rating determined in block 1712, such as by transmitting the images and the similarity rating to a remote operator to supplement the remote operator's subjective assessment of whether the image of the user's face matches the image of the user's ID card. Verifying the user's identity can be performed by a human operator assisted by the similarity score, or by an automated system, as described in detail above.

In decision block 1716, the routine 1700 determines whether the user's identity is verified. If the user's identity has not been verified, then in block 1718 the app can display a message declining the transaction and/or encouraging the user to bring the target device and ID card to the kiosk to reattempt verification. On the other hand, if the user's identity has been verified, then in block 1720 the routine 1700 can record the user's photo image and feature data as described above with reference to block 420 of FIG. 4. In block 1722, the app can display instructions for completing the requested transaction (e.g., recycling the target device at a kiosk, via mail, or via a delivery service). In some embodiments, the routine 1700 provides the user a confirmation or redemption code identifying the verified user and/or the transaction, so that the user can enter the code at the kiosk or print and include the code with the target device by mail to complete the transaction. Thus, for example, if the user later takes the target device to the kiosk and enters the code, the routine 1700 can determine that the entered code is associated with the verified user, and proceed with the user's transaction. After block 1716, the routine 1700 ends.

In various embodiments, all or a portion of the routines in the flow diagrams described herein can be implemented by means of a consumer or other user (such as a retail employee) operating one or more of the electronic devices and systems described above. In some embodiments, portions (e.g., blocks) of the routines can be performed by one or more of a plurality of kiosks, such as the kiosks 100a-100n of FIG. 16, and/or by one or more remote computers. For example, such remote computers can include one or more of the server computers 1604 and/or computing resources associated with the cloud 1626, the resale marketplace 1630, and/or the kiosk operator 1632 operating separately or in combination. Such remote computers can also include the electronic device 1530, such as a user's mobile device running an app. The kiosk 100 and/or the remote computers can perform the routines described herein using one or more local and/or remote databases (e.g., the database 1606). Accordingly, the descriptions of the routines disclosed herein may refer interchangeably to the routine, the kiosk 100, a remote server, and/or an electronic device of the user performing an operation, with the understanding that any of the above devices, systems, and resources can perform all or part of the operation.

The kiosks 100, electronic devices 1530 (e.g., mobile devices), server computers 1604, user computers or devices 1618, etc. can include one or more central processing units or other logic-processing circuitry, memory, input devices (e.g., keyboards and pointing devices), output devices (e.g., display devices and printers), and storage devices (e.g., magnetic, solid state, fixed and floppy disk drives, optical disk drives, etc.). Such computers can include other program modules such as an operating system, one or more application programs (e.g., word processing or spreadsheet applications), and the like. The computers can include wireless computers, such as mobile phones, personal digital assistants (PDAs), palm-top computers, tablet computers, notebook and laptop computers desktop computers, e-readers, music players, GPS devices, wearable computers such as smartwatches and Google® Glass™, etc., that communicate with the Internet via a wireless link. The computers may be general-purpose devices that can be programmed to run various types of applications, or they may be single-purpose devices optimized or limited to a particular function or class of functions. Aspects of the invention may be practiced in a variety of other computing environments.

While the Internet is shown, a private network such as an intranet can likewise be used herein. The network can have a client-server architecture, in which a computer is dedicated to serving other client computers, or it can have other architectures such as peer-to-peer, in which one or more computers serve simultaneously as servers and clients. A database or databases, coupled to the server computer(s), stores much of the web pages and content exchanged between the user computers. The server computer(s), including the database(s), can employ security measures to inhibit malicious attacks on the system, and to preserve integrity of the messages and data stored therein (e.g., firewall systems, message encryption and/or authentication (e.g., using transport layer security (TLS) or secure sockets layer (SSL)), password protection schemes, encryption of stored data (e.g., using trusted computing hardware), and the like).

One skilled in the relevant art will appreciate that the concepts of the invention can be used in various environments other than location based or the Internet. In general, a display description can be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, can be used instead of the Internet. The system can be conducted within a single computer environment, rather than a client/server environment. Also, the user computers can comprise any combination of hardware or software that interacts with the server computer, such as television-based systems and various other consumer products through which commercial or noncommercial transactions can be conducted. The various aspects of the invention described herein can be implemented in or for any e-mail environment.

Although not required, aspects of the invention are described in the general context of computer-executable instructions, such as routines executed by a data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules can be located in both local and remote memory storage devices.

Those of ordinary skill in the art will appreciate that the routines and other functions and methods described herein can be implemented as an application specific integrated circuit (ASIC), by a digital signal processing (DSP) integrated circuit, through conventional programmed logic arrays and/or circuit elements. While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

Aspects of the invention can be stored or distributed on tangible computer-readable media, including magnetically or optically readable computer discs, hard-wired or preprogrammed chips (e.g., EEPROM semiconductor chips), nanotechnology memory, or other data storage media. The data storage devices can include any type of computer-readable media that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a transitory propagating signal per se.

The above Detailed Description of examples and embodiments of the invention is not intended to be exhaustive or to limit the invention to the precise form disclosed above. Although specific examples for the invention are described above for illustrative purposes, various equivalent modifications are possible within the scope of the invention, as those skilled in the relevant art will recognize.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

Although the above description describes various embodiments of the invention and the best mode contemplated, regardless how detailed the above text, the invention can be practiced in many ways. Details of the system may vary considerably in its specific implementation, while still being encompassed by the present technology. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

We claim:

1. A system for verifying the identity of a user of a consumer-operated kiosk, the system comprising:
at least one imaging device configured to obtain a first image of the user when the user is present at the kiosk; and
at least one processor configured to execute computer-readable instructions that cause the processor to perform a method including:
comparing the first image to a second image; and
determining a level of similarity of the first image to the second image based on the comparison.

2. The system of claim 1, further comprising a second imaging device, wherein the second imaging device obtains the second image from an ID card of the user at the kiosk.

3. The system of claim 1, further comprising a remote computer, wherein the method further includes providing information related to the level of similarity to the remote computer for display to an operator prior to the user completing a transaction at the kiosk.

4. The system of claim 1, further comprising a remote computer, wherein determining a level of similarity includes generating a similarity score based on the comparison, and wherein the method further includes:
transmitting the similarity score to the remote computer for display to an operator;
in response to the transmission, receiving a signal from the remote computer; and
allowing the user to complete a transaction at the kiosk based on the signal.

5. The system of claim 1, further comprising a remote computer, wherein determining a level of similarity includes generating a similarity score based on the comparison, and wherein the method further includes:
generating an action recommendation based on the similarity score; and
transmitting the similarity score and the action recommendation to the remote computer for display to an operator prior to the user completing a transaction at the kiosk.

6. The system of claim 1 wherein determining a level of similarity includes determining a similarity rating, and wherein when the similarity rating is above a preset threshold, the user is allowed to complete a transaction at the kiosk.

7. The system of claim 1 wherein determining a level of similarity includes determining a similarity rating, and wherein when the similarity rating is below the preset threshold, the user is prevented from completing the transaction.

8. The system of claim 1 wherein determining a level of similarity includes determining a similarity rating, wherein when the similarity rating is below a preset threshold, the user is allowed to complete a transaction at the kiosk

9. The system of claim 1 wherein determining a level of similarity includes determining a similarity rating, and wherein when the similarity rating is above the preset threshold, the user is prevented from completing the transaction.

10. The system of claim 1 wherein the first image and the second image are facial images, and wherein:
comparing the first image to the second image includes:
generating first facial feature data from the first image, wherein the first facial feature data represents facial features of the user;
generating second facial feature data from the second image; and
comparing the first facial feature data to the second facial feature data; and
determining a level of similarity of the first image to the second image includes determining a level of similarity based on the comparison of the first facial feature data to the second facial feature data.

11. The system of claim 1 wherein the at least one imaging device configured to obtain a first image of the user includes a biometric reader configured to obtain an image of a fingerprint of the user.

12. A consumer operated kiosk system, the kiosk system comprising:
a kiosk for recycling electronic devices, the kiosk having:
a camera; and
a processor configured to execute computer-readable instructions to obtain, via the camera, a first image of a kiosk user conducting a transaction at the kiosk;
a feature recognition component configured to generate a first numerical representation of features of the first image; and
a feature comparison component configured to:
compare the first numerical representation to a second numerical representation of features of a second image of a person; and
determine a level of similarity of the first image of the kiosk user to the second image of the person based on the comparison of the first numerical representation to the second numerical representation.

13. The kiosk system of claim 12 wherein the processor is further configured to:
transmit the first image, the second image, and the level of similarity to a remote verification facility; and
receive, from the remote verification facility, a signal indicating whether to allow the user to complete the transaction at the kiosk.

14. The kiosk system of claim 12 wherein the kiosk further includes an ID card scanner, and wherein the processor is further configured to obtain the second image from an ID card via the ID card scanner.

15. The kiosk system of claim 12 wherein the second image is an image of a blocked user, and wherein the processor is further configured to automatically prevent the user from completing the transaction at the kiosk if the level of similarity exceeds a threshold.

16. The kiosk system of claim 12, further comprising:
a database containing, for each of a plurality of blocked users, a blocked user image and a numerical representation of features of the blocked user image; and
wherein the processor is further configured to obtain the second numerical representation from the database.

17. The kiosk system of claim 12 wherein the second image is an image of an approved user, and wherein the processor is further configured to automatically allow the user to complete the transaction at the kiosk if the level of similarity exceeds a threshold.

18. The kiosk system of claim 12 wherein the second image is an image of an individual authorized to service the kiosk, and wherein the processor is further configured to permit the user to gain access to the inside of the kiosk if the level of similarity exceeds a threshold.

19. The kiosk system of claim 12, further comprising:
a database containing, for each of a plurality of approved users, an approved user image and a numerical representation of features of the approved user image; and
wherein the processor is further configured to obtain the second numerical representation from the database.

20. The kiosk system of claim 12 wherein the kiosk further includes an ID card scanner, and wherein the processor is further configured to execute computer-readable instructions to:
obtain, via the ID card scanner, identifying information from an ID card provided by the user; and
obtain the second numerical representation from a database based on the identifying information.

21. A method for controlling use of a consumer operated kiosk, the method comprising:
generating, by a processor operably coupled to the kiosk, first feature data representing features of a first image of a kiosk user;
comparing the first feature data to second feature data to determine a level of similarity of the first feature data to the second feature data,
wherein the second feature data represent features of a second image.

22. The method of claim 21, further comprising obtaining a first image of the user when the user is present at the kiosk.

23. The method of claim 21, further comprising:
obtaining a second image of at least a portion of an ID card provided by the user; and
generating, by the processor, second feature data representing features of the second image.

24. The method of claim 21 wherein the kiosk is a consumer operated kiosk for recycling electronic devices.

25. The method of claim 21, further comprising verifying the identity of the user based at least in part on the level of similarity.

26. The method of claim 21 wherein comparing the first feature data to the second feature data includes:
determining, by a processor operably coupled to the kiosk, a degree of correlation between values in the first feature data and values representative of an item that the user may be wearing;
determining whether the degree of correlation exceeds a threshold; and
if the degree of correlation exceeds a threshold, prompting the user to remove the item.

27. The method of claim 21 wherein the ID card contains descriptive information, and wherein obtaining the second image includes obtaining the descriptive information, and further comprising:
determining expected feature data based on the descriptive information;
comparing the first feature data to the expected feature data to rate a second level of similarity of the first feature data to the expected feature data.

28. The method of claim 21, further comprising:
displaying information via the kiosk;
identifying a facial expression based on the first feature data;
estimating a user emotional response based on the facial expression; and
associating the estimated emotional response with the information.

29. The method of claim 21, further comprising:
identifying a facial expression based on the first feature data; and
categorizing the expression as positive or negative.

30. A method for verifying the identity of a user of a mobile electronic device having a camera, the method comprising:
obtaining a first image of the user via the camera;
obtaining a second image of at least a portion of a personal ID card via the camera;
generating, by a processor, first feature data representing features of the first image and second feature data representing features of the second image; and
comparing the first feature data to the second feature data to determine a level of similarity of the first image to the second image.

31. The method of claim 30 wherein the mobile electronic device includes the processor.

32. The method of claim 30 wherein the processor is remote from the mobile electronic device.

33. The method of claim 30, further comprising transmitting the first image and the second image to a remote computer,
wherein the remote computer performs the generating and comparing.

34. The method of claim 30, further comprising:
transmitting the first image and the second image to a verification facility; and
in response to the transmission, receiving a verification indication based on the level of similarity.
